(19) United States
(12) Patent Application Publication
(10) Pub. No.: US 2008/0114740 A1
(43) Pub. Date: May 15, 2008

(54) SYSTEM AND METHOD FOR MAINTAINING CONFORMANCE OF ELECTRONIC DOCUMENT STRUCTURE WITH MULTIPLE, VARIANT DOCUMENT STRUCTURE MODELS

(75) Inventor: Grant Vergottini, San Marcos, CA (US)

Correspondence Address: KNOBBE MARTENS OLSON & BEAR LLP, 2040 MAIN STREET, FOURTEENTH FLOOR, IRVINE, CA, 92614, US

(73) Assignee: Xcential Group LLC, Encinitas, CA (US)

(21) Appl. No.: 11/940,207

(22) Filed: Nov. 14, 2007

Related U.S. Application Data
(60) Provisional application No. 60/865,773, filed on Nov. 14, 2006.

(51) Int. Cl. G06F 7/06; G06F 7/00

(52) U.S. Cl. 707/3; 707/101; 707/102; 707/E17.124; 707/E17.127

(57) ABSTRACT

Embodiments include a system and method of facilitating the control and management of information and actions related to the computerized creation, maintenance, processing, storage, retrieval, and use of structured electronic documents in a manner such that collections of documents which are closely related with regard to structure can be stored and maintained in conformance with a single, underlying, abstract document structure model while concurrently conforming to a user-defined document structure model.

### RELATED APPLICATIONS

This application claims the benefit of, and incorporates by reference in its entirety, U.S. Provisional Application No. 60/865,773, filed on Nov. 14, 2006.

### BACKGROUND OF THE INVENTION

1. Field of the Invention

The present invention generally relates to the field of creation, maintenance, and use of structured electronic documents.

2. Description of the Related Technology

As the number of electronic documents being created, maintained, and used increases, there is a growing need for techniques to process structured electronic documents efficiently and with cost effectiveness.

At one time the creation, maintenance, and use of electronic documents were done on a largely ad hoc basis. The computer provided little functionality beyond that of a typewriter. The identification of logical structural components within an electronic document was done rarely; and then typically only for obvious situations such as titles, headings, and footnotes. The structural consistency of a document was maintained manually, if at all, by a typist, operator, or document specialist. This process was slow, tedious, and prone to error.

Thus, there is a need for systems and methods of quickly implementing customized versions of electronic document application software in situations involving organizations where the same underlying document structure is employed among many (or all) organizations in the same industry group.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the features of this invention provide advantages that include providing for efficient and cost-effective maintenance and use of these collections of documents.

Embodiments include a system and method that facilitates the control and management of information and actions related to the computerized creation, maintenance, processing, storage, retrieval, and use of structured electronic documents in a manner such that collections of documents which are closely related with regard to structure can be stored and maintained in conformance with a single, underlying, document structure model. Further, the system and method facilitates the control and management of information and actions related to the computerized creation, maintenance, processing, storage, retrieval, and use of structured electronic documents in a manner such that individual documents can be stored and maintained in conformance with a user-defined document structure model.

One embodiment includes a method of converting a structured document from a first schema to a second schema. The method comprises receiving a first structured document comprising at least one element conforming to a first schema. The method further comprises identifying a declaration in the first schema and a declaration in the abstract schema that is associated with the element. The declaration of the first schema is derived from the declaration in the abstract schema. The method further comprises identifying a declaration in a second schema that is derived from the declaration in the abstract schema. The method further comprises generating an element of a second structured document based at least partly on the declaration in the second schema. The element of the second document conforms to the second schema.

One embodiment includes a method of generating a structured document. The method comprises receiving at least one element conforming to a first schema, identifying a declaration in the first schema that is associated with the received element and which is derived from a declaration in an abstract schema, and generating an element of a structured document based at least partly on the declaration in the abstract schema. The element of the structured document conforms to the first schema.

One embodiment includes an XML document stored on a computer readable medium. the document comprises at least one element conforming to a concrete schema derived from an abstract schema. The concrete schema comprises a plurality of declarations derived from respective declarations of the abstract schema.

One embodiment includes a method of searching structured documents. The method comprises receiving a query request comprising query terms conforming to an abstract schema. The method further comprises identifying at least one declaration of at least one concrete schema, the declaration being derived from a declaration of the abstract schema. The method further comprises identifying query terms conforming to the concrete schema. The identifying is based on the at least one declaration of the concrete schema and the received query request. The method further comprises comparing the query terms conforming to the concrete schema to at least one structured document conforming to the concrete schema. The method further comprises determining whether the at least one structured document conforming to the concrete schema matches the query request.

One embodiment includes a method of generating a standalone schema for defining structured documents. The method comprises receiving an abstract schema, receiving a concrete schema derived from the abstract schema, the concrete schema comprising a plurality of element definitions, and generating element definitions of a standalone schema based on the plurality of element definitions of the concrete schema and on declarations derived from the element definitions of the abstract schema.

### BRIEF DESCRIPTION OF THE DRAWINGS

FIG. 1 is a high-level functional block diagram of an embodiment of a traditional system used to create and maintain conforming document instances within the context of an XML-based document markup language.

FIG. 2 is a high-level functional block diagram according to one embodiment of the invention.

FIG. 3 is a block diagram which illustrates an embodiment of process of creating an Abstract XML Schema.

FIG. 4 shows examples of “book” and “short story” documents that may be used with various embodiments.

FIG. 5 is a block diagram which illustrates an embodiment of a process of creating a Concrete XML Schema.

FIG. 6 is a block diagram which illustrates an embodiment of a method of creating and maintaining document instances using an embodiment of the invention.

FIG. 7 is a block diagram that illustrates an embodiment of a conversion of a document instance from conforming with one Concrete XML Schema to conforming to another Concrete XML Schema, provided both Concrete XML Schemas are derived from the same Abstract XML Schema.

FIG. 8 is a flowchart illustrating one embodiment of a method of searching XML documents conforming to Concrete XML Schemas.

FIG. 9 is a flowchart illustrating one embodiment of a method of generating a Standalone XML Schema.

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

As the discipline of electronic document management advanced, techniques and related tools have been developed to impose, maintain, and enforce well-defined mathematical structure upon documents and the interrelationships among document components. National and international standards, such as SGML and derivative languages such as XML, were developed to provide fundamental methods for defining electronic document structure. In actual document instances, the structure can be instantiated by delimiting document components (also known as elements) with tags taken from the document structure model using a process termed markup.

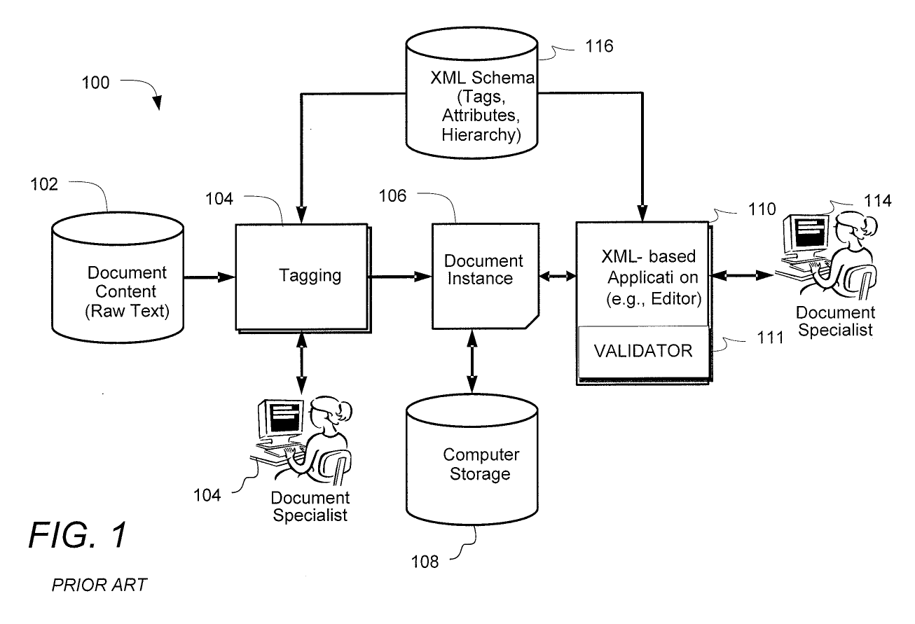

FIG. 1 is a high-level functional block diagram of an embodiment of a system 100 used to create and maintain conforming document instances within the context of an XML-based document markup language. A document 102 comprising raw text may be received by the system 100. The creation of an XML document instance may include applying markup to nested blocks of raw text in a process termed “tagging,” e.g., via a tagging module 104. The tags used to mark up the raw text are obtained from an XML schema 116, which defines the permissible structure of a valid document instance. The markup may be applied manually by a document specialist 104 or through programmatic means. The result of the tagging process is a file, termed a “document instance” 106, which contains the document content and markup. The markup defines the hierarchical structure of the content within the document instance 106 and provides optional information which, if present, associates attributes with each of the document elements. Once created, an XML document instance 106 is typically stored on computer media 108, such as a disk drive, for subsequent maintenance and use.

Still referring to FIG. 1, the subsequent maintenance and use of an XML document instance 106 may include retrieving the document instance 107 and associated XML schema 116 from computer storage. A document specialist 114 interacts with the document instance 106, under the control of the XML schema 116, using XML-based application software 110, which can perform a variety of actions. These actions may include, but are not limited to, editing the document instance, querying information within the document instance, and formatting the document instance for visual presentation. The XML-based application software 110 may include an embedded XML validation module that determines conformance of the document instance 106 with the validator 111.

Standards groups within many different subject matter areas have developed collections of electronic document structure models to facilitate the creation, maintenance, and use of common and frequently used documents within their respective industries. Among other benefits, the use of standard electronic document structure models facilitated intra-company, inter-company, and the inter-system transfer of electronic documents, with an observed increase in efficiency and cost-effectiveness.

Although the use of structured electronic documents based upon standard electronic document structure models provides significant cost and productivity benefits for back-end processing (that is, the transfer and processing of information among computers), the development of front-end document processing systems (that is, those systems which involve human-machine interaction) still tends to be slow and expensive due to frequent needs to provide customized user interfaces and/or customized electronic document processing applications.

Some of the need for customized user interfaces and document processing applications arises from differences in the working terminology used by different companies, organizations, or applications for the same structural components within structured electronic documents. To cite some examples:
In the shipping industry, different companies may refer to the container within which freight is shipped by different names—car, box, crate, cask, etc.—despite the objects' fundamental, underlying identity of being a container;
In a publishing company, the creator of a piece of writing may be referred to by different terms depending upon the type of writing—author, writer, submitter, poet, etc.—despite the person's fundamental, underlying identity of being the creator;
In government, different state legislatures may refer to equivalent parts of bills and laws by different names despite the structural and contextual equivalence.

Despite the structural equivalence of electronic documents within each of these “industry groups” of documents, it is not unusual for individual companies or organizations to demand that specialized electronic document application software be developed to handle the unique terminology (markup tags) employed in their specific implementation of the standard structure. The time and effort consumed in the process of building these custom implementations of electronic document application software can be significant. Accordingly, one embodiment includes a system and method that provides the ability to maintain a document instance in concurrent conformance with both a single, underlying, document structure model and a user-defined document structure mode.

In addition to the accompanying drawings, details of embodiments of the present invention, both as to structure and operation, may be gleaned in part by study of the accompanying listings provided in tables herein. The listings are not necessarily complete, but rather are provided to illustrate the principles of various embodiments.

The ability to maintain a document instance in concurrent conformance with both a single, underlying, document structure model and a user-defined document structure model is accomplished by maintaining two related schemas in association with the document instance. These schemas include:
Abstract Schema: contains a definition of the common underlying model of the document structure. The definition of the underlying document structure is made using abstract, rather than concrete, identifiers for the document components or elements. The use of abstract identifiers allows the Abstract Schema to be used in conjunction with many variant Concrete Schemas.
Concrete Schema: contains the user model of the document structure and identifies the document components using names obtained from the user model. The Concrete Schema also contains information that associates the names obtained from the user model with common underlying role names which are ultimately associated with the document structure model that is contained within the Abstract Schema.

In an embodiment of the invention, structurally-equivalent document instances used within one industry or group of organizations would be associated with the same Abstract Schema, which defines document structure in abstract terms according to the common underlying model. Document instances in each, individual, company, or organization would be associated with a Concrete Schema which applies only to that company or organization. To cite some examples:
In one embodiment, in the shipping industry, all shipping companies would be structurally conformant with the same, single Abstract Schema for all instances of equivalent documents. This provides common document structure among all companies. Additionally, each company would use a different Concrete Schema to reflect the differences in otherwise equivalent names—car, box, crate, cask, for example—along with an associated reference to a fundamental, underlying identifier—container, for example—to tie the individual user terminology with the underlying abstract model of document structure;
In one embodiment, in a publishing company, all pieces of writing would be structurally conformant with the same, single Abstract Schema. This provides common document structure among all pieces of writing. Additionally, each specific type of writing—book, short story, essay, for example—would use a different Concrete Schema to reflect the differences in otherwise equivalent names—author, writer, submitter, for example—along with an associated reference to a fundamental, underlying identifier—creator, for example—to tie the terminology with the underlying abstract model of document structure;
In one embodiment, in government, all state legislatures would be structurally conformant with the same, single Abstract Schema for all instances of legislative bills since the structure of all bills is substantially the same for all states. Additionally, each state would use a different Concrete Schema to account for the naming differences in otherwise equivalent legislative terms used among the states along with associated references to fundamental, underlying identifiers to tie the state's terminology with the underlying abstract model of document structure.

In one embodiment, electronic document application software, such as a document editor, may read information from both the Abstract Schema and the Concrete Schema in addition to the document instance. When the document specialist interacts with the application software, the user interface would present the document instance to the document specialist using the user-defined model contained within the Concrete Schema. Internally, and hidden from the user, the application software would be maintaining document structure and element identities according to the underlying model contained within the Abstract Schema.

By enforcing the concurrent compliance of a document instance with both the Abstract Schema and a Concrete Schema, in one embodiment, the system: 1) preserves the user's view of the document structure and component identity, thereby achieving ease of use and conformance to user standards; and 2) allows a single set of document maintenance tools to operate, with minimal modification or customization, upon document instances which conform to a variety of different user-defined document structure models. The method by which different document instances, which conform to a variety of different Concrete Schemas, are made to conform to a single, underlying, Abstract Schema embodies the claim.

Also, in one embodiment, the system facilitates the creation of a Concrete Schema from an annotated instance of a document that is tagged in conformance with a Standalone Schema; that is, a schema that does not embody the system. As used herein, a standalone schema is a schema that can be used independently of any abstract schema or any concrete schema, such as described herein. This provides a method for inducting or importing document instances into an electronic document management system that embodies the system.

Also, one embodiment of the system facilitates the conversion of a Concrete Schema to a Standalone Schema in a manner such that a document instance will comply concurrently with both schemas without the need for modifying the document instance. This provides a mechanism for exporting document instances to electronic document management systems that do not embody the system.

Assuming that two Concrete Schemas are related to the same Abstract Schema, an embodiment may also facilitate the conversion of document instances from conforming to one Concrete Schema to conforming to a different Concrete Schema. This capability facilitates the transfer of document instances among organizations that use different Concrete Schemas that are related to the same Abstract Schema.

Embodiments may provide one or more of the following advantages:
Provide a document specialist a system and method to create, view, and maintain structured electronic documents using a concrete (user-defined) model and document structure model while concurrently allowing an electronic document management system to store, maintain, and retrieve the same document using an abstract (underlying) model and document structure model. Conformance with a concrete model and document structure model facilitates ease of use and adherence to user standards, while concurrent conformance with an underlying abstract document model and structure model facilitates ease of electronic document application software development and maintenance.
Provide a way of generating a Concrete Schema (which is based upon, and derived from, an Abstract Schema) from an annotated document instance that conforms to a Standalone Schema.
Provide a way for electronic document application software to hide (encapsulate) the underlying abstract document structure and its associated abstract document component identifiers from the user.
Provides for a single set of electronic document application software tools which include, but are not limited to, structured document editors and display programs, to be used to maintain a variety of electronic documents which conform to different document structure models with minimal need for modification or customization.
Provides for the use, transfer, and reuse of structured document instances and structured document components in different environments that use different user-defined document structure models without the need to perform manual re-tagging.
Provides for the generation of a Standalone Schema from a Concrete Schema. The resultant Standalone Schema can be used in the creation of document instances in other environments.
Provides for a document instance that is tagged in conformance with a concrete document structure model and its underlying abstract model to be formatted and displayed according to presentation rules that are associated with the concrete document structure model.
Provides for a collection of document instances to be queried in a manner such that a query can be submitted using terms defined by the Abstract Schema and query results can be displayed using “user” terms defined by the Concrete Schema.

### 1. Overview of One Embodiment

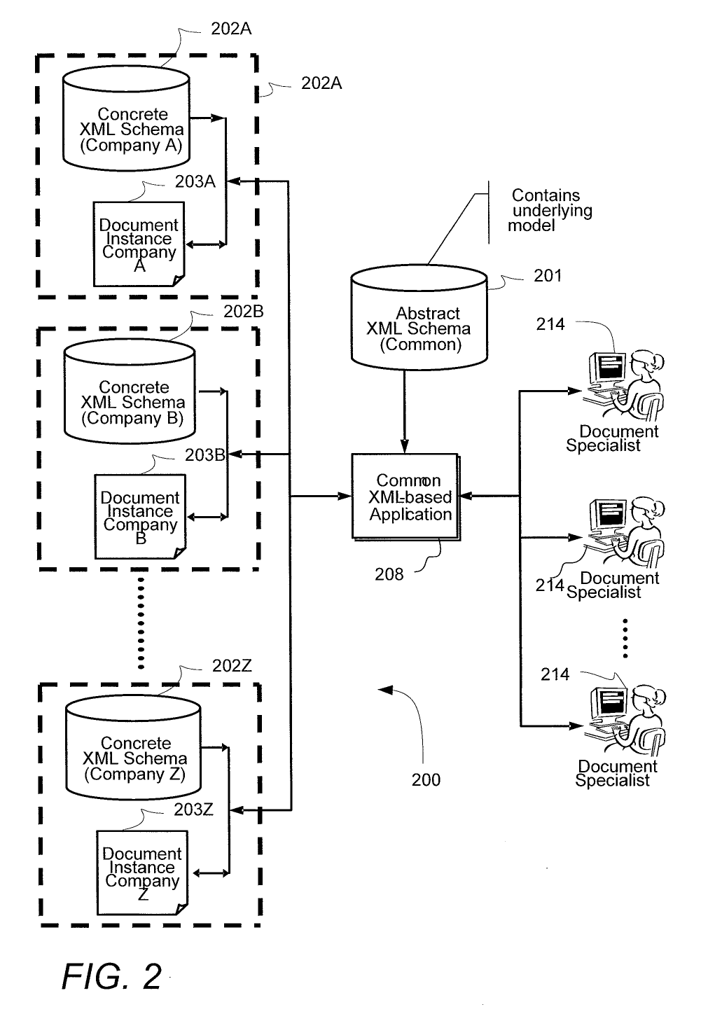

FIG. 2 is a high-level functional block diagram of an embodiment of a system 200 that includes Concrete XML Schemas 202A, 202B, and 202Z (collectively “202”) which are related to, and which derive from, an Abstract Schema 201 which contains a definition of the common underlying model of the document structure for respective collections of document instances 203A, 203B, and 203Z (collectively “203”) which are closely related with regard to structure. Although documents in each collection are structurally related, individual document instances 203A, 203B, and 203Z may be associated with different companies, organizational units, or variant subject matter applications; in FIG. 2, this is indicated by the “Company A, B, . . . , Z” annotation. A different Concrete XML Schema 202 is associated with each of the A, B, . . . , Z subsets of document instances 203. Each Concrete XML Schema 202 contains the user model of the document structure and identifies the document components using names obtained from the user model. Each Concrete XML Schema 202 also contains information that associates the names obtained from the user model with common underlying role names which are ultimately associated with the document structure model that is contained within the Abstract XML Schema 201. Each Concrete XML Schema contains a reference to the Abstract XML Schema 201, which effectively ties the two schemas together for the purpose of document application processing.

Continuing with FIG. 2, the system 200 may include one or more instances of Common XML-based Application Software 208 which can embody logic to perform functional operations upon the document instances. The functions of the XML-based Application Software 208 may include, but are not limited to, editing the document instance, 203 querying information within the document instance 203, and formatting the document instance 203 for visual presentation. An embodiment within the Common XML-based Application Software 208 may provide the ability for a single application software module to perform similar functional operations upon any document instance 203 that is associated with the Abstract XML Schema 201, irrespective of which of the Concrete XML Schemas 202 with which the document instances 203 are associated. Thus, with respect to the example illustrated in FIG. 2, the same application software module 208 can process any document instance 203A, 203B, and 203Z (i.e., in the A, B, . . . , or Z subsets) of the collection of structurally related documents.

As the application software module 208 may read both the Concrete XML Schema 203 associated with any particular document instance along with the Abstract XML Schema 201, the user model associated with the document instance 203 is the model that will be presented to a document specialist 214 when the document is processed by the application software module 208. The underlying model contained within the Abstract XML Schema 201, upon which the Concrete XML Schema 202 is derived, will be used by the application software module 208 but may be encapsulated and hidden from the document specialist 214. An observable effect may be to give the document specialist 214 the impression that the application software module 208 is customized to the specific user model with which the document specialist 214 is familiar. Desirably, the application software module 208 is thus able to process any document instance 203 that is associated with the Abstract XML Schema 201, with minimal application software customization.

### 2. Embodiment by XML Element Attributes

An embodiment includes the definition and use of four XML element attributes that facilitate the ability of an XML document instance to concurrently conform to two interrelated XML schemas, the Abstract XML Schema and a derived Concrete XML Schema. In one embodiment, the names (which identify function properties) of these element attributes can be:
base
type
class
role

These four attributes are defined in the Abstract XML Schema 201 as an attribute group and should not be confused with the similar or identical standard XML names:

TABLE 1
1: <xsd:attributeGroup name=“derivationGroup”>
2: <xsd:attribute name=“class” type=“xsd:string” use=“optional”/>
3: <xsd:attribute name=“base” type=“xsd:string” use=“optional”/>
4: <xsd:attribute name=“type” type=“xsd:string” use=“optional”/>
5: <xsd:attribute name=“role” type=“xsd:string” use=“optional”/>
6: </xsd:attributeGroup>

The four attributes are used, variously, in the Abstract XML Schema 201, the Concrete XML Schema 202, and document instances 203 represented in the associated Abstract XML Schema 201, as described in further detail below.

### 2.1. BASE Attribute

The base attribute is used within Concrete XML Schemas 202 to associate a type definition with an element name located in the Abstract XML Schema 201. For example, see the illustrative use of the base attribute on line 6 in Table 2 below:

TABLE 2

| | |
|---|---|
| 1: | <xsd:complexType name=“TitleType”> |
| 2: | <xsd:simpleContent> |
| 3: | <xsd:restriction base=“xsim:PropertyType”> |
| 4: | <xsd:attribute name=“class” |
| 5: | type=“xsd:string” fixed=“Title”/> |
| 6: | <xsd:attribute name=“base” |
| 7: | type=“xsd:string” fixed=“xsim:Property”/> |
| 8: | <xsd:attribute name=“role” |
| 9: | type=“xsd:string” fixed=“dc:title”/> |
| 10: | </xsd:restriction> |
| 11: | </xsd:simpleContent> |
| 12: | </xsd:complexType> |

where the Abstract XML Schema contains the element declaration:
<xsd:element name=“Property” type=“PropertyType”/>

The base attribute, which typically has a fixed value defined in the Concrete Schema 202, is found in the markup for a document instance 203 when the document instance is being annotated for the purpose of deriving a Concrete XML Schema 202 from it.

### 2.2. TYPE Attribute

The type attribute is used within Concrete XML Schemas 202 to override, at the application software level, the inherent data type that is defined in the Abstract XML Schema 201. In practical use, the effect of the type attribute is to restrict the data type of an element to a greater extent than the data type declared within the Abstract XML Schema 201. The data type override or restriction declared by the type attribute is enforced by the document application software, not by the schema.

To illustrate use of the type attribute, the following example is provided. An example of an Abstract XML Schema 202 defines PropertyType as shown in Table 3:

TABLE 3

1: <xsd:complexType name=“PropertyType”>
2: <xsd:simpleContent>
3: <xsd:extension base=“xsd:string”>
4: <xsd:attributeGroup ref=“derivationGroup”/>
5: </xsd:extension>
6: </xsd:simpleContent>
7: </xsd:complexType>

Note, on line 3 of Table 3 above, that PropertyType is defined as an xsd:string. In a Concrete XML Schema 202 (see listing below in Table 4) that has been derived from the above example of the Abstract XML Schema 201, note that PublishedType (line 1) is derived from PropertyType (line 3) thus defining, by inheritance, the default data type of PublishedType as xsd:string. Use of the type attribute (lines 10-11) in the Concrete XML Schema 202 defines a data type of xsd:date, which indicates to the application software that the data type for PublishedType elements is xsd:date rather than the more general xsd:string. Note that the schema still regards the data type of PublishedType as xsd:string; it is the application software that reads the data type override of xsd:date from the Concrete XML Schema 202 and enforces that definition.

TABLE 4

| | |
|---|---|
| 1: | <xsd:complexType name=“PublishedType”> |
| 2: | <xsd:simpleContent> |
| 3: | <xsd:restriction base=“xsim:PropertyType”> |
| 4: | <xsd:attribute name=“class” type=“xsd:string” |
| 5: | fixed=“Published”/> |
| 6: | <xsd:attribute name=“base” type=“xsd:string” |
| 7: | fixed=“xsim:Property”/> |
| 8: | <xsd:attribute name=“role” type=“xsd:string” |
| 9: | fixed=“dcterms:issued”/> |
| 10: | <xsd:attribute name=“type” type=“xsd:string” |
| 11: | fixed=“xsd:date”/> |
| 12: | </xsd:restriction> |
| 13: | </xsd:simpleContent> |
| 14: | </xsd:complexType> |

The type attribute, which typically has a fixed value defined in the Concrete Schema, is found in the markup for a document instance only when the document instance is being annotated for the purpose of deriving a Concrete XML Schema from it.

### 2.3. CLASS Attribute

The class attribute is used within examples of the Abstract and Concrete XML Schemas 201 and 202 to associate user-defined element names with structural components that are defined in the underlying model. This allows document application software, such as interactive document editors, to present document structure to the document specialist in user-defined terms (that is, in the terms of the user model) rather than in the terms of the underlying abstract model. Further, this allows a collection of document instances to be queried in a manner such that a query can be submitted using terms defined by the Abstract Schema 201 while the results of the query can be displayed using “user” terms defined by the Concrete Schema 202 (example of queries are presented in the Concept of Operations section of this patent description). Additionally, encoding user-defined element names in attributes named “class” facilitates the document management system's use of Cascading Style Sheets for formatting information when displaying or presenting the formatted document instance visually.

Examples of equivalent type definitions from two different Concrete XML Schemas 202 follow in Table 5. Note that, although both declarations refer to the same, equivalent structural element in the document—namely the creator of a book or story—the class attribute for the declaration in one Concrete XML Schema 202 is named Author and the class attribute for the declaration in the other Concrete XML Schema 202 is named Submitter:

TABLE 5

| | |
|---|---|
| 1: | <xsd:complexType name=“AuthorType”> |
| 2: | <xsd:simpleContent> |
| 3: | <xsd:restriction base=“xsim:PropertyType”> |
| 4: | <xsd:attribute name=“class” type=“xsd:string” |
| 5: | fixed=“Author”/> |
| 6: | <xsd:attribute name=“base” type=“xsd:string” |
| 7: | fixed=“xsim:Property”/> |
| 8: | <xsd:attribute name=“role” type=“xsd:string” |
| 9: | fixed=“dc:creator”/> |
| 10: | </xsd:restriction> |
| 11: | </xsd:simpleContent> |
| 12: | </xsd:complexType> |
| 1: | <xsd:complexType name=“SubmitterType”> |
| 2: | <xsd:simpleContent> |
| 3: | <xsd:restriction base=“xsim:PropertyType”> |
| 4: | <xsd:attribute name=“class” type=“xsd:string” |
| 5: | fixed=“Submitter”/> |
| 6: | <xsd:attribute name=“base” type=“xsd:string” |
| 7: | fixed=“xsim:Property”/> |
| 8: | <xsd:attribute name=“role” type=“xsd:string” |
| 9: | fixed=“dc:creator”/> |
| 10: | </xsd:restriction> |
| 11: | </xsd:simpleContent> |
| 12: | </xsd:complexType> |

In document instances represented in the Abstract XML Schema 201, element tags include the class attribute in order to specify the user-defined name of the element. The examples below illustrate the use of the class attribute in two document instances 203 represented in the same Abstract XML Schema 201, but associated with two different user models. Note that one tag defines the class as Author and the other tag defines the class as Submitter, although the value of the role attribute (refer to section 2.4 for a description of the role attribute) for both examples is dc: creator. This indicates that both tagged elements are logically equivalent (according to the underlying model embodied in the Abstract XML Schema 201); however, one user model refers to the creator of the document as the Author, whereas the other user model refers to the creator of the document as the Submitter:

TABLE 6
1: <xsim:Property class=“Author”
2: role=“dc:creator”>Herman Melville</xsim:Property>
1: <xsim:Property class=“Submitter”
2: role=“dc:creator”>Herman Melville</xsim:Property>

The class attribute is not used in document instances represented in a Concrete XML Schema 202 because the value of the class attribute is already represented by the tag name; however, when a document instance that is represented in the Abstract XML Schema 201 is converted to a document instance that conforms to a Concrete XML Schema 202, the values of the class attributes are used as the element names for the tags in the concrete document instance 203. For example: Consider a document instance 203 that is represented in the Abstract XML Schema 201 of Table 7:

TABLE 7
1: <xsim:Property class=“Author”
2: role=“dc:creator”>Herman Melville</xsim:Property>

Conversion to a document instance that is represented in a Concrete XML Schema 202 simply produces the output shown in Table 8:

TABLE 8

1: <Author>Herman Melville</Author>

### 2.4. ROLE Attribute

The role attribute is used to associate a concrete element with the corresponding name defined in the underlying model. For greatest practical usefulness, the name in the underlying model may be a term assigned by a standards body or industry consortium. Given a set of different Concrete XML Schemas 202 hat have been derived from the same Abstract XML Schema 201, elements with the same value for the role attribute are logically and structurally equivalent from the point of view of the underlying model, despite the element names possibly being different.

The examples below illustrate the use of the role attribute in two different Concrete XML Schemas 202 which are derived from the same Abstract XML Schema 201. Note that one tag defines the class as Author and the other tag defines the class as Submitter, although the value of the role attribute (refer to section 2.3 for a description of the class attribute) for both examples is dc: creator. This indicates that both declarations are declaring the same underlying document component with different names based upon different user models as shown in Table 9.

TABLE 9

| | |
|---|---|
| 1: | <xsd:complexType name=“AuthorType”> |
| 2: | <xsd:simpleContent> |
| 3: | <xsd:restriction base=“xsim:PropertyType”> |
| 4: | <xsd:attribute name=“class” type=“xsd:string” |
| 5: | fixed=“Author”/> |
| 6: | <xsd:attribute name=“base” type=“xsd:string” |
| 7: | fixed=“xsim:Property”/> |
| 8: | <xsd:attribute name=“role” type=“xsd:string” |
| 9: | fixed=“dc:creator”/> |
| 10: | </xsd:restriction> |
| 11: | </xsd:simpleContent> |
| 12: | </xsd:complexType> |
| 1: | <xsd:complexType name=“SubmitterType”> |
| 2: | <xsd:simpleContent> |
| 3: | <xsd:restriction base=“xsim:PropertyType”> |
| 4: | <xsd:attribute name=“class” type=“xsd:string” |
| 5: | fixed=“Submitter”/> |
| 6: | <xsd:attribute name=“base” type=“xsd:string” |
| 7: | fixed=“xsim:Property”/> |
| 8: | <xsd:attribute name=“role” type=“xsd:string” |
| 9: | fixed=“dc:creator”/> |
| 10: | </xsd:restriction> |
| 11: | </xsd:simpleContent> |
| 12: | </xsd:complexType> |

In document instances represented in the Abstract XML Schema 201, element tags include the role attribute in order to specify the underlying abstract name associated with the element. The examples below illustrate the use of the role attribute in two document instances represented in the same Abstract XML Schema 201, but based upon two different derived Concrete XML Schemas 202. Note that although one tag defines the class as Author and the other defines the class as Submitter, the value of the role attribute for both is dc: creator. This indicates that both tagged elements are logically identical according to the underlying model embodied in the Abstract XML Schema 201; however, they are represented with different names according to the user models shown in Table 10.

TABLE 10
1: <xsim:Property class=“Author”
2: role=“dc:creator”>Herman Melville</xsim:Property>
1: <xsim:Property class=“Submitter”
2: role=“dc:creator”>Herman Melville</xsim:Property>

In document instances associated with a Concrete XML Schema 202, the role attribute is not used because the role attribute information is contained within the schema rather than within the document instance.

### 3. Concept of Operations

Embodiments support several operational scenarios, which are described and illustrated. These operational scenarios include:
Creating an Abstract XML Schema
Creating a Concrete XML Schema
Creating and Maintaining a Document Instance
Converting a Document Instance from One Concrete XML Schema to Another
Querying a Collection of Document Instances
Converting a Concrete XML Schema to a Standalone XML Schema

Depending upon the specific task to be performed, one or more of several series of alternative processing steps may be taken, not all of which are illustrated below. These processing scenarios are presented not to limit the processing capabilities of the system, but rather to illustrate salient features of the certain embodiments.

### 3.1. Creating an Abstract XML Schema

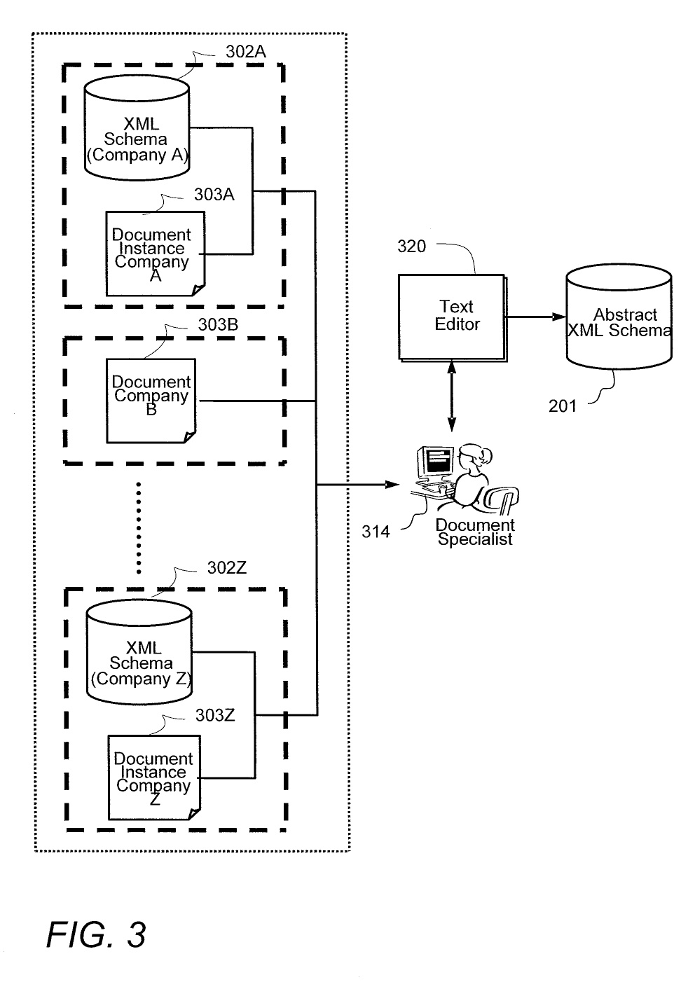

In one embodiment, FIG. 3 is a data flow diagram that illustrates the process of creating an Abstract XML Schema 201. The Abstract XML Schema 201 contains a definition of the common underlying model of the document structure for a collection of document instances 203 which are closely related with regard to structure.
The process of creating an Abstract XML Schema 201 starts with a document specialist 314, who may, for example, work with (or is sponsored by) an industry initiative or an organization concerned with sharing documents within an industry. The document specialist 314 assembles a collection of related documents, related XML document instances 303 and, optionally, their associated XML schemas 302.
Working within the document component and structural definitions prescribed by the industry initiative or organization or other criteria, the document specialist 314 examines the documents 303 and schemas 302 to identify and assign underlying roles to document components that are common among the candidate documents. The document specialist 314 also determines the interrelationships among different document components.
Using the information obtained from the document and schema analysis, the document specialist 314 uses a text editor 320 to create the Abstract XML Schema 201.
Using the information obtained from the document and schema analysis, the document specialist assigns and documents the names of the underlying document component roles for later use in the assignment of role and class attribute values during the creation of Concrete XML Schemas 202 (such as illustrated in FIG. 2).

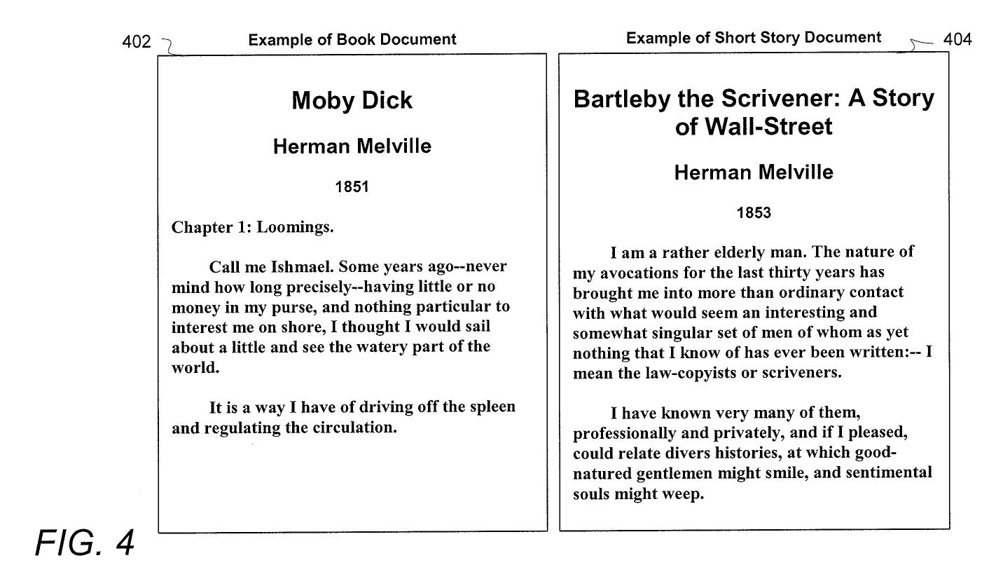

FIG. 4 illustrates two documents that represent a book and a short story (the examples are significantly abbreviated not due to limitations in the processing capabilities of the system, but rather to illustrate salient features of the certain embodiments without introducing extraneous information) and are used to illustrate the creation of an Abstract XML Schema 201 from a small collection of structurally related documents.

Listing 1 in Table 11 provides an example of an Abstract XML Schema 201 which captures the structural model that underlies the book and short-story examples.

TABLE 11
Listing 1: Abstract XML Schema Example (xsim.xsd)

| 1: | <?xml version=“1.0” standalone=“no”?> | |
|---|---|---|
| 2: | <xsd:schema targetNamespace=“urn:xcential:xsim” | |
| 3: | xmlns=“urn:xcential:xsim” | |
| 4: | xmlns:xsd=“http://www.w3.org/2001/XMLSchema” | |
| 5: | elementFormDefault=“qualified” | |
| 6: | attributeFormDefault=“unqualified” | |
| 7: | version=“1.0”> | |
| 8: | | |
| 9: | <xsd:annotation> | |
| 10: | <xsd:documentation> | |
| 11: | | |
| 12: | | |
| 13: | ---------------------------------------------------------------------------------------------------- | |
| 14: | XCENTIAL SIMPLIFIED INFORMATION MODEL (XSIM) | |
| 15: | ---------------------------------------------------------------------------------------------------- | |
| 16: | | |
| 17: | </xsd:documentation> | |
| 18: | </xsd:annotation> | |
| 19: | | |
| 20: | <!-- ============================================== --> | |
| 21: | <!-- Attribute Groups --> | |
| 22: | <!-- ============================================== --> | |
| 23: | | |
| 24: | <xsd:attributeGroup name=“derivationGroup”> | |
| 25: | <xsd:attribute name=“class” type=“xsd:string” use=“optional”/> | |
| 26: | <xsd:attribute name=“base” type=“xsd:string” use=“optional”/> | |
| 27: | <xsd:attribute name=“type” type=“xsd:string” use=“optional”/> | |
| 28: | <xsd:attribute name=“role” type=“xsd:string” use=“optional”/> | |
| 29: | </xsd:attributeGroup> | |
| 30: | | |
| 31: | <!-- ============================================== --> | |
| 32: | <!-- Definitions --> | |
| 33: | <!-- ============================================== --> | |
| 34: | | |
| 35: | | |
| 36: | <xsd:complexType name=“DocumentType”> | |
| 37: | <xsd:sequence> | |
| 38: | <xsd:element ref=“Property” | minOccurs=“0” |
| 39: | | maxOccurs=“unbounded”/> |
| 40: | <xsd:element ref=“Division” | minOccurs=“0” |
| 41: | | maxOccurs=“unbounded”/> |
| 42: | </xsd:sequence> | |
| 43: | <xsd:attributeGroup ref=“derivationGroup”/> | |
| 44: | </xsd:complexType> | |
| 45: | | |
| 46: | | |
| 47: | <xsd:complexType name=“PropertyType”> | |
| 48: | <xsd: simpleContent> | |
| 49: | <xsd:extension base=“xsd:string”> | |
| 50: | <xsd:attributeGroup ref=“derivationGroup”/> | |
| 51: | </xsd:extension> | |
| 52: | </xsd:simpleContent> | |
| 53: | </xsd:complexType> | |
| 54: | | |
| 55: | <xsd:complexType name=“DivisionType”> | |
| 56: | <xsd:sequence> | |
| 57: | <xsd:element ref=“Block” maxOccurs=“unbounded”/> | |
| 58: | </xsd:sequence> | |
| 59: | <xsd:attributeGroup ref=“derivationGroup”/> | |
| 60: | </xsd:complexType> | |
| 61: | | |
| 62: | <xsd:complexType name=“BlockType”> | |
| 63: | <xsd:simpleContent> | |
| 64: | <xsd:extension base=“xsd:string”> | |
| 65: | <xsd:attributeGroup ref=“derivationGroup”/> | |
| 66: | </xsd:extension> | |
| 67: | </xsd:simpleContent> | |
| 68: | </xsd:complexType> | |
| 69: | | |
| 70: | <!-- ============================================== --> | |
| 71: | <!-- Declarations --> | |
| 72: | <!-- ============================================== --> | |
| 73: | | |
| 74: | <xsd:element name=“Document” | type=“DocumentType”/> |
| 75: | <xsd:element name=“Property” | type=“PropertyType”/> |
| 76: | <xsd:element name=“Division” | type=“DivisionType”/> |
| | <xsd:element name=“Block” | type=“BlockType”/> |
| | </xsd:schema> | |

### 3.2. Creating a Concrete XML Schema

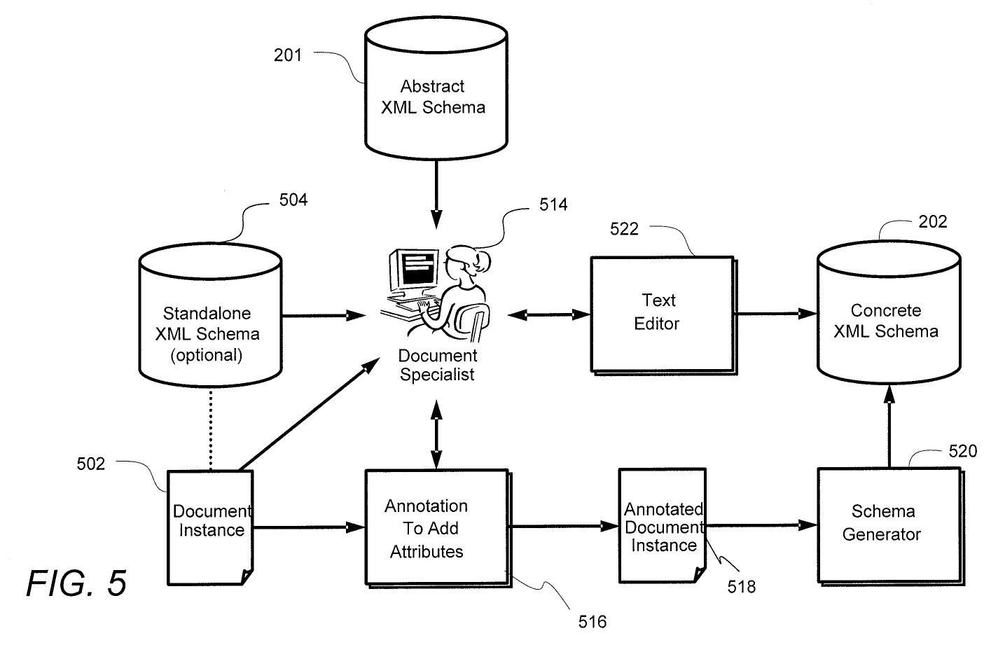

FIG. 5 is a data flow diagram that illustrates one embodiment of a process of creating a Concrete XML Schema 202. Each Concrete XML Schema 202 contains the user model of the document structure and identifies the document components using names obtained from the user model. Each Concrete XML Schema 202 also contains information that associates the names obtained from the user model with common underlying role names which are ultimately associated with the document structure definition that is contained within the Abstract XML Schema 201. Each Concrete XML Schema 202 contains a reference to the Abstract XML Schema 201, which effectively ties the two schemas together for the purpose of document application processing.

Referring to FIG. 5, each Concrete XML Schema 202 can be created manually or semi-automatically, with the aid of a programmatic schema generator. In one embodiment, the steps of creating a Concrete XML Schema manually, using a text editor, include:
A document specialist/schema designer 514 may assemble:
one or more representative document instances 502,
optionally, an XML schema upon which the document instance is based (this XML schema is referred to as a Standalone XML Schema 504),
an Abstract XML Schema 201 that was created from a collection of documents that included the document instance and/or Standalone XML Schema 504,
documentation related to the Abstract XML Schema 201 that describes the base, type, class, and role attribute values needed to relate the Concrete XML Schema 202 with the Abstract XML Schema 201 and associated document instances 502.

The document specialist 314 examines the document instance 502, Standalone XML Schema 504, and Abstract XML Schema 201 to perform a mapping of identifiers and structure used in the document instance with the abstract logical document structure that is defined in the Abstract XML Schema 201.

Using the information obtained from the document and schema analysis, the document specialist uses a text editor 522 to create a Concrete XML Schema 202 for the specific document type embodied by the document instance and/or Standalone XML Schema 504. The Concrete XML Schema 202 comprises constructs (based upon the four XML element attributes of one embodiment) that allow the structure of a conforming document instance 502 to be mapped into the abstract model defined by the Abstract XML Schema 201.

As an alternative to creating a Concrete XML Schema 202 manually using a text editor 522, the document specialist/schema designer 514 may annotate the document instance 502 via an annotation module (which may be include text editor) with information according to one embodiment to produce an annotated document instance 518. A Schema Generator program module 520 reads the annotated document instance and programmatically generate the Concrete XML Schema 202. The steps of creating a Concrete XML Schema programmatically may include the following.
1. The document specialist/schema designer 514 obtains or creates a document instance in which the first occurrence of each element is representative of the information that will be found in most document instances 502.
2. The document specialist/schema designer 514 annotates the document instance 502 to produce an annotated document instance 518. This annotation may include adding the base and (optionally) the role and type attributes to the first occurrence of each element in the document 502. The base attribute specifies the element in the Abstract XML Schema 201 from which the Concrete element is to be derived. The role attribute attaches a higher level meaning to the element. The type attribute specifies a (generally more restrictive) data type which overrides, at the application software level, the data type acquired through inheritance from the Abstract XML Schema 201.
3. The Schema Generator 520 analyzes the annotated document instance and the document's base schema 518. The Schema Generator 520 produces an initial Concrete XML Schema 202 to which the document instance 502 will conform. The Schema Generator 520 pay perform the following in analyzing the annotated document instance 518 and in producing the initial Concrete XML Schema 202:
   a. The root level element of the annotated document instance 518 is read for namespace information.
   b. The first occurrence of each element in the annotated document instance 518 is identified.
   c. For each unique element in the base schema, a global element is defined and declared in the Concrete XML Schema 202.
   d. For each element definition in the Concrete XML Schema 202, the name of the element is taken from the name of the corresponding element in the annotated document instance. Additionally, a class attribute is defined for each element in the Concrete XML Schema 202. The default value of each class attribute is the same as the name of the corresponding element in the annotated document instance 518.
   e. For each first occurrence of every element in the annotated document instance 518, if a base attribute is found within the element tag, the element definition in the Concrete XML Schema 202 will derive from the element in the Abstract XML Schema 201 that is named by the value of the base attribute. In this event, the base attribute and its value will be added to the definition of the corresponding element in the Concrete XML Schema.
   f. For each first occurrence of every element in the annotated document instance 518, if a role attribute is found within the element tag, the role attribute and its value will be added to the definition of the corresponding element in the Concrete XML Schema 202.
   g. For each first occurrence of every element in the annotated document instance 518, if a type attribute is found within the element tag, the type attribute and its value will be added to the definition of the corresponding element in the Concrete XML Schema 202.
4. The document specialist/schema designer 514 may make any appropriate changes to the generated Concrete XML Schema 202 to handle situations that were not, or could not, be represented in the first instance of each element in the annotated document instance 518.

Examples of Concrete XML Schemas 202, derived from the “book” and “story” examples provided earlier in FIG. 4, follow Listing 2 in Table 12, which illustrates a tagged, standalone document instance for the “book” example in FIG. 4.

TABLE 12
Listing 2: Example Standalone Document Instance for “Book”

| | |
|---|---|
| 1: | <?xml version=“1.0” encoding=“UTF-8” standalone=“yes”?> |
| 2: | <Book> |
| 3: | <Title>Moby Dick</Title> |
| 4: | <Author>Herman Melville</Author> |
| 5: | <Printed>1851</Printed> |
| 6: | <Chapter> |
| 7: | <Heading>Chapter 1: Loomings.</Heading> |
| 8: | <Paragraph>Call me Ishmael. |
| 9: | Some years ago--never mind how long precisely-having |
| 10: | little or no money in my purse, and nothing particular |
| 11: | to interest me on shore, I thought I would sail about |
| 12: | a little and see the watery part of the world.</Paragraph> |
| 13: | <Paragraph>It is a way I have of driving off |
| 14: | the spleen and regulating the circulation.</Paragraph> |
| 15: | </Chapter> |
| 16: | </Book> |

Listing 3 in Table 13 shows the same document instance for the “book” example in listing 2 after it has been annotated in preparation for generating a corresponding Concrete XML Schema 202. Annotations have been underlined for clarity.

TABLE 13
Listing 3: Example Annotated Document Instance for “Book”

| | |
|---|---|
| 1: | <?xml version=“1.0” encoding=“UTF-8” standalone=“yes”?> |
| 2: | <Book |
| 3: | xmlns=“urn:xcential:book” |
| 4: | xmlns:xsi=“http://www.w3.org/2001/XMLSchema-instance” |
| 5: | xsi:schemaLocation=“urn:xcential:book ./book.xsd” |
| 6: | base=“xsim:Document”> |
| 7: | <Title base=“xsim:Property” role=“dc:title”>Moby Dick</Title> |
| 8: | <Author base=“xsim:Property” role=“dc:creator”>Herman |
| 9: | Melville</Author> |
| 10: | <Printed base=“xsim:Property” role=“dcterms:issued” |
| 11: | type=“xsd:date”>1851</Printed> |
| 12: | <Chapter base=“xsim:Division”> |
| 13: | <Heading base=“xsim:Block” role=“xhtml:h1”>Chapter 1: |
| 14: | Loomings.</Heading> |
| 15: | <Paragraph base=“xsim:Block” role=“xhtml:p”>Call me |
| | Ishmael. |
| 16: | Some years ago--never mind how long precisely-having |
| 17: | little or no money in my purse, and nothing particular |
| 18: | to interest me on shore, I thought I would sail about |
| 19: | a little and see the watery part of the world.</Paragraph> |
| 20: | <Paragraph>It is a way I have of driving off |
| 21: | the spleen and regulating the circulation.</Paragraph> |
| 22: | </Chapter> |
| 23: | </Book> |

Listing 4 in Table 14 shows a Concrete XML Schema 202 derived from the Abstract XML Schema 201 provided in Listing 1 and the annotated document instance for the “book” example provided in Listing 3.

TABLE 14
Listing 4: Concrete XML Schema Example for Book Content (book.xsd)

| 1: | <?xml version=“1.0” standalone=“no”?> | |
|---|---|---|
| 2: | <xsd:schema targetNamespace=“urn:xcential:book” | |
| 3: | xmlns=“urn:xcential:book” | |
| 4: | xmlns:xsim=“urn:xcential:xsim” | |
| 5: | xmlns:dc=“http://purl.org/dc/elements/1.1/” | |
| 6: | xmlns:xhtml=“http://www.w3.org/1999/xhtml” | |
| 7: | xmlns:xsd=“http://www.w3.org/2001/XMLSchema” | |
| 8: | elementFormDefault=“qualified” | |
| 9: | attributeFormDefault=“unqualified” | |
| 10: | version=“1.0”> | |
| 11: | | |
| 12: | <xsd:annotation> | |
| 13: | <xsd:documentation> | |
| 14: | | |
| 15: | | |
| 16: | ------------------------------------------------------------------------------------------- | |
| 17: | XCENTIAL BOOK | |
| 18: | ------------------------------------------------------------------------------------------- | |
| 19: | | |
| 20: | </xsd:documentation> | |
| 21: | </xsd:annotation> | |
| 22: | | |
| 23: | <xsd:import namespace=“urn:xcential:xsim” | |
| 24: | schemaLocation=“./xsim.xsd”/> | |
| 25: | | |
| 26: | <!-- ============================================= --> | |
| 27: | <!-- Definitions --> | |
| 28: | <!-- ============================================= --> | |
| 29: | | |
| 30: | <xsd:complexType name=“BookType”> | |
| 31: | <xsd:complexContent> | |
| 32: | <xsd:restriction base=“xsim:DocumentType”> | |
| 33: | <xsd:sequence> | |
| 34: | <xsd:element ref=“xsim:Property” | minOccurs=“0” |
| 35: | maxOccurs=“unbounded”/> | |
| 36: | <xsd:element ref=“Chapter” | minOccurs=“0” |

| 37: | maxOccurs=“unbounded”/> | |
|---|---|---|
| 38: | </xsd:sequence> | |
| 39: | <xsd:attribute name=“class” | type=“xsd:string” |
| 40: | | fixed=“Book”/> |
| 41: | <xsd:attribute name=“base” | type=“xsd:string” |
| 42: | | fixed=“xsim:Document”/> |
| 43: | | |
| 44: | </xsd:restriction> | |
| 45: | </xsd:complexContent> | |
| 46: | </xsd:complexType> | |
| 47: | | |
| 48: | <xsd:complexType name=“TitleType”> | |
| 49: | <xsd:simpleContent> | |
| 50: | <xsd:restriction base=“xsim:PropertyType”> | |
| 51: | <xsd:attribute name=“class” | type=“xsd:string” |
| 52: | | fixed=“Title”/> |
| 53: | <xsd:attribute name=“base” | type=“xsd:string” |
| 54: | | fixed=“xsim:Property”/> |
| 55: | <xsd:attribute name=“role” | type=“xsd:string” |
| 56: | | fixed=“dc:title”/> |
| 57: | </xsd:restriction> | |
| 58: | </xsd:simpleContent> | |
| 59: | </xsd:complexType> | |
| 60: | | |
| 61: | | |
| 62: | <xsd:complexType name=“AuthorType”> | |
| 63: | <xsd:simpleContent> | |
| 64: | <xsd:restriction base=“xsim:PropertyType”> | |
| 65: | <xsd:attribute name=“class” | type=“xsd:string” |
| 66: | | fixed=“Author”/> |
| 67: | <xsd:attribute name=“base” | type=“xsd:string” |
| 68: | | fixed=“xsim:Property”/> |
| 69: | <xsd:attribute name=“role” | type=“xsd:string” |
| 70: | | fixed=“dc:creator”/> |
| 71: | </xsd:restriction> | |
| 72: | </xsd:simpleContent> | |
| 73: | </xsd:complexType> | |
| 74: | | |
| 75: | <xsd:complexType name=“PrintedType”> | |
| 76: | <xsd:simpleContent> | |
| 77: | <xsd:restriction base=“xsim:PropertyType”> | |
| 78: | <xsd:attribute name=“class” | type=“xsd:string” |
| 79: | | fixed=“Printed”/> |
| 80: | <xsd:attribute name=“base” | type=“xsd:string” |
| 81: | | fixed=“xsim:Property”/> |
| 82: | <xsd:attribute name=“role” | type=“xsd:string” |
| 83: | | fixed=“dcterms:issued”/> |
| 84: | <xsd:attribute name=“type” | type=“xsd:string” |
| 85: | | fixed=“xsd:date”/> |
| 86: | </xsd:restriction> | |
| 87: | </xsd:simpleContent> | |
| 88: | </xsd:complexType> | |
| 89: | | |
| 90: | | |
| 91: | <xsd:complexType name=“ChapterType”> | |
| 92: | <xsd:complexContent> | |
| 93: | <xsd:restriction base=“xsim:DivisionType”> | |
| 94: | <xsd:sequence> | |
| 95: | <xsd:element ref=“xsim:Block” maxOccurs=“unbounded”/> | |
| 96: | </xsd:sequence> | |
| 97: | <xsd:attribute name=“class” | type=“xsd:string” |
| 98: | | fixed=“Chapter”/> |
| 99: | <xsd:attribute name=“base” | type=“xsd:string” |
| 100: | | fixed=“xsim:Division”/> |
| 101: | </xsd:restriction> | |
| 102: | </xsd:complexContent> | |
| 103: | </xsd:complexType> | |
| 104: | | |
| 105: | | |
| 106: | <xsd:complexType name=“HeadingType”> | |
| 107: | <xsd:simpleContent> | |
| 108: | <xsd:restriction base=“xsim:BlockType”> | |
| 109: | <xsd:attribute name=“class” | type=“xsd:string” |
| 110: | | fixed=“Heading”/> |
| 111: | <xsd:attribute name=“base” | type=“xsd:string” |
| 112: | | fixed=“xsim:Block”/> |
| 113: | <xsd:attribute name=“role” | type=“xsd:string” |
| 114: | | fixed=“xhtml:h1”/> |
| 115: | </xsd:restriction> | |
| 116: | </xsd:simpleContent> | |
| 117: | </xsd:complexType> | |
| 118: | | |
| 119: | <xsd:complexType name=“ParagraphType”> | |
| 120: | <xsd:simpleContent> | |
| 121: | <xsd:restriction base=“xsim:BlockType”> | |
| 122: | <xsd:attribute name=“class” | type=“xsd:string” |
| 123: | | fixed=“Paragraph”/> |
| 124: | <xsd:attribute name=“base” | type=“xsd:string” |
| 125: | | fixed=“xsim:Block”/> |
| 126: | <xsd:attribute name=“role” | type=“xsd:string” |
| 127: | | fixed=“xhtml:p”/> |
| 128: | | |

| 129: | </xsd:restriction> | |
|---|---|---|
| 130: | </xsd:simpleContent> | |
| 131: | </xsd:complexType> | |
| 132: | | |
| 133: | <!-- ============================================== --> | |
| 134: | <!-- Declarations --> | |
| 135: | <!-- ============================================== --> | |
| 136: | | |
| 137: | <xsd:element name=“Book” | type=“BookType” |
| 138: | | substitutionGroup=“xsim:Document”/> |
| 139: | <xsd:element name=“Title” | type=“TitleType” |
| 140: | | substitutionGroup=“xsim:Property”/> |
| 141: | <xsd:element name=“Author” | type=“AuthorType” |
| 142: | | substitutionGroup=“xsim:Property”/> |
| 143: | <xsd:element name=“Printed” | type=“PrintedType” |
| 144: | | substitutionGroup=“xsim:Property”/> |
| 145: | <xsd:element name=“Chapter” | type=“ChapterType” |
| 146: | | substitutionGroup=“xsim:Division”/> |
| | <xsd:element name=“Heading” | type=“HeadingType” |
| | | substitutionGroup=“xsim:Block”/> |
| | <xsd:element name=“Paragraph” | type=“ParagraphType” |
| | | substitutionGroup=“xsim:Block”/> |
| | </xsd:schema> | |

Listing 5 in Table 15 shows a tagged, standalone document instance for the “short story” example in FIG. 4.

TABLE 15
Listing 5: Example Standalone Document Instance for “Story”

| | |
|---|---|
| 1: | <?xml version=“1.0” encoding=“UTF-8” standalone=“yes”?> |
| 2: | <Story> |
| 3: | <Title>Bartleby the Scrivener: A Story of Wall-Street</Title> |
| 4: | <Submitter>Herman Melville</Submitter> |
| 5: | <Published>1853</Published> |
| 6: | <Body> |
| 7: | <Para>I am a rather elderly man. The nature of my |
| 8: | avocations for the last thirty years has brought me into |
| 9: | more |
| 10: | than ordinary contact with what would seem an interesting |
| 11: | and |
| 12: | somewhat singular set of men of whom as yet nothing that I |
| 13: | know of has ever been written:-- I mean the law-copyists |
| 14: | or |
| 15: | scriveners.</Para> |
| 16: | <Para>I have known very many of them, |
| 17: | professionally and privately, and if I pleased, could |
| 18: | relate |
| | divers histories, at which good-natured gentlemen might |
| | smile, and sentimental souls might weep.</Para> |
| | </Body> |
| | </Story> |

Listing 6 in Table 16 shows the same document instance for the “story” example in listing 5 after it has been annotated in preparation for generating a corresponding Concrete XML Schema 202. Annotations have been underlined for clarity.

TABLE 16
Listing 6: Example Annotated Document Instance for “Story”

| | |
|---|---|
| 1: | <?xml version=“1.0” encoding=“UTF-8” standalone=“yes”?> |
| 2: | <Story |
| 3: | xmlns=“urn:xcential:story” |
| 4: | xmlns:xsi=“http://www.w3.org/2001/XMLSchema-instance” |
| 5: | xsi:schemaLocation=“urn:xcential:story ./story.xsd” |
| 6: | base=“xsim:Document”> |
| 7: | <Title base=“xsim:Property” role=“dc:title”>Bartleby the |
| 8: | Scrivener: |
| 9: | A Story of Wall-Street</Title> |
| 10: | <Submitter base=“xsim:Property” role=“dc:creator”>Herman |
| 11: | Melville</Submitter> |
| 12: | <Published base=“xsim:Property” role=“dcterms:issued” |
| 13: | type=“xsd:date”>1853</Published> |
| 14: | <Body base=“xsim:Division”> |
| 15: | <Para base=“xsim:Block” role=“xhtml:p”>I am a rather elderly |
| 16: | man. The nature of my |
| 17: | avocations for the last thirty years has brought me into |
| 18: | |
| 19: | more |
| 20: | than ordinary contact with what would seem an interesting |
| 21: | and |
| 22: | somewhat singular set of men of whom as yet nothing that I |
| 23: | know of has ever been written:-- I mean the law-copyists or |
| 24: | scriveners.</Para> |
| 25: | <Para>I have known very many of them, |
| 26: | professionally and privately, and if I pleased, could |
| | relate |
| | divers histories, at which good-natured gentlemen might |
| | smile, and sentimental souls might weep.</Para> |
| | </Body> |
| | </Story> |

### Listing 7 in Table 17 shows the Concrete XML Schema 202 derived from the Abstract XML Schema 201 provided in Listing 1 and the annotated document instance 518 for the “story” example provided in Listing 6.

TABLE 17
Listing 7: Concrete XML Schema Example for Story Content (story.xsd)

| 1: | <?xml version=“1.0” standalone=“no”?> | |
|---|---|---|
| 2: | <xsd:schema targetNamespace=“urn:xcential:story” | |
| 3: | xmlns=“urn:xcential:story” | |
| 4: | xmlns:xsim=“urn:xcential:xsim” | |
| 5: | xmlns:dc=“http://purl.org/dc/elements/1.1/” | |
| 6: | xmlns:xhtml=“http://www.w3.org/1999/xhtml” | |
| 7: | xmlns:xsd=“http://www.w3.org/2001/XMLSchema” | |
| 8: | elementFormDefault=“qualified” | |
| 9: | attributeFormDefault=“unqualified” | |
| 10: | version=“1.0”> | |
| 11: | | |
| 12: | | |
| 13: | <xsd:annotation> | |
| 14: | <xsd:documentation> | |
| 15: | | |
| 16: | -------------------------------------------------------------------------------------------- | |
| 17: | -- | |
| 18: | XCENTIAL STORY | |
| 19: | -------------------------------------------------------------------------------------------- | |
| 20: | -- | |
| 21: | | |
| 22: | </xsd:documentation> | |
| 23: | </xsd:annotation> | |
| 24: | | |
| 25: | <xsd:import namespace=“urn:xcential:xsim” | |
| 26: | schemaLocation=“./xsim.xsd”/> | |
| 27: | | |
| 28: | <!-- ============================================== - | |
| 29: | -> | |
| 30: | <!-- Definitions - | |
| 31: | -> | |
| 32: | <!-- ============================================== - | |
| 33: | -> | |
| 34: | | |
| 35: | | |
| 36: | <xsd:complexType name=“StoryType”> | |
| 37: | <xsd:complexContent> | |
| 38: | <xsd:restriction base=“xsim:DocumentType”> | |
| 39: | <xsd:sequence> | |
| 40: | <xsd:element ref=“xsim:Property” minOccurs=“0” | |
| 41: | | |
| 42: | maxOccurs=“unbounded”/> | |
| 43: | <xsd:element ref=“Body”/> | |
| 44: | </xsd:sequence> | |
| 45: | <xsd:attribute name=“class” | type=“xsd:string” |
| 46: | | fixed=“Story”/> |
| 47: | <xsd:attribute name=“base” | type=“xsd:string” |
| 48: | | fixed=“xsim:Document”/> |
| 49: | </xsd:restriction> | |
| 50: | </xsd:complexContent> | |
| 51: | </xsd:complexType> | |
| 52: | | |
| 53: | <xsd:complexType name=“TitleType”> | |
| 54: | <xsd:simpleContent> | |
| 55: | <xsd:restriction base=“xsim:PropertyType”> | |
| 56: | <xsd:attribute name=“class” | type=“xsd:string” |
| 57: | | fixed=“Title”/> |
| 58: | <xsd:attribute name=“base” | type=“xsd:string” |
| 59: | | fixed=“xsim:Property”/> |
| 60: | <xsd:attribute name=“role” | type=“xsd:string” |
| 61: | | fixed=“dc:title”/> |
| 62: | | |
| 63: | </xsd:restriction> | |
| 64: | </xsd:simpleContent> | |
| 65: | </xsd:complexType> | |
| 66: | | |
| 67: | <xsd:complexType name=“SubmitterType”> | |
| 68: | <xsd:simpleContent> | |
| 69: | <xsd:restriction base=“xsim:PropertyType”> | |
| 70: | <xsd:attribute name=“class” | type=“xsd:string” |
| 71: | | fixed=“Submitter”/> |
| 72: | <xsd:attribute name=“base” | type=“xsd:string” |
| 73: | | fixed=“xsim:Property”/> |
| 74: | <xsd:attribute name=“role” | type=“xsd:string” |
| 75: | | fixed=“dc:creator”/> |
| 76: | </xsd:restriction> | |
| 77: | </xsd:simpleContent> | |
| 78: | </xsd:complexType> | |
| 79: | | |
| 80: | | |
| 81: | <xsd:complexType name=“PublishedType”> | |
| 82: | <xsd:simpleContent> | |
| 83: | <xsd:restriction base=“xsim:PropertyType”> | |
| 84: | <xsd:attribute name=“class” | type=“xsd:string” |
| 85: | | fixed=“Published”/> |
| 86: | <xsd:attribute name=“base” | type=“xsd:string” |
| 87: | | fixed=“xsim:Property”/> |
| 88: | <xsd:attribute name=“role” | type=“xsd:string” |
| 89: | | fixed=“dcterms:issued”/> |
| 90: | <xsd:attribute name=“type” | type=“xsd:string” |
| 91: | | fixed=“xsd:date”/> |
| 92: | </xsd:restriction> | |
| 93: | </xsd:simpleContent> | |
| 94: | </xsd:complexType> | |
| 95: | | |
| 96: | | |
| 97: | <xsd:complexType name=“BodyType”> | |
| 98: | <xsd:complexContent> | |
| 99: | <xsd:restriction base=“xsim:DivisionType”> | |
| 100: | <xsd:sequence> | |
| 101: | <xsd:element ref=“Para” maxOccurs=“unbounded”/> | |
| 102: | </xsd:sequence> | |
| 103: | <xsd:attribute name=“class” | type=“xsd:string” |
| 104: | | fixed=“Body”/> |
| 105: | <xsd:attribute name=“base” | type=“xsd:string” |
| 106: | | fixed=“xsim:Division”/> |
| 107: | </xsd:restriction> | |
| 108: | </xsd:complexcontent> | |
| 109: | </xsd:complexType> | |
| 110: | | |
| 111: | <xsd:complexType name=“ParaType”> | |
| 112: | <xsd:simpleContent> | |
| 113: | <xsd:restriction base=“xsim:BlockType”> | |
| 114: | <xsd:attribute name=“class” | type=“xsd:string” |
| 115: | | fixed=“Para”/> |
| 116: | <xsd:attribute name=“base” | type=“xsd:string” |
| 117: | | fixed=“xsim:Block”/> |
| 118: | <xsd:attribute name=“role” | type=“xsd:string” |
| 119: | | fixed=“xhtml:p”/> |

| 120: | </xsd:restriction> | |
|---|---|---|
| 121: | </xsd:simpleContent> | |
| 122: | </xsd:complexType> | |
| 123: | | |
| 124: | | |
| 125: | <!-- ============================================== - | |
| 126: | -> | |
| 127: | <!-- Declarations - | |
| 128: | -> | |
| 129: | <!-- ============================================== - | |
| 130: | -> | |
| 131: | | |
| | <xsd:element name=“Story” | type=“StoryType” |
| | | substitutionGroup=“xsim:Document”/> |
| | <xsd:element name=“Title” | type=“TitleType” |
| | | substitutionGroup=“xsim:Property”/> |
| | <xsd:element name=“Submitter” | type=“SubmitterType” |
| | | substitutionGroup=“xsim:Property”/> |
| | <xsd:element name=“Published” | type=“PublishedType” |
| | | substitutionGroup=“xsim:Property”/> |
| | <xsd:element name=“Body” | type=“BodyType” |
| | | substitutionGroup=“xsim:Division”/> |
| | <xsd:element name=“Para” | type=“ParaType” |
| | | substitutionGroup=“xsim:Block”/> |
| | </xsd:schema> | |

### 3.3. Creating and Maintaining a Document Instance

Using one or more XML-based applications, a document specialist 514 can create, edit, refine, maintain, query, and otherwise process a document instance that conforms to a Concrete XML Schema using a system according to one embodiment.

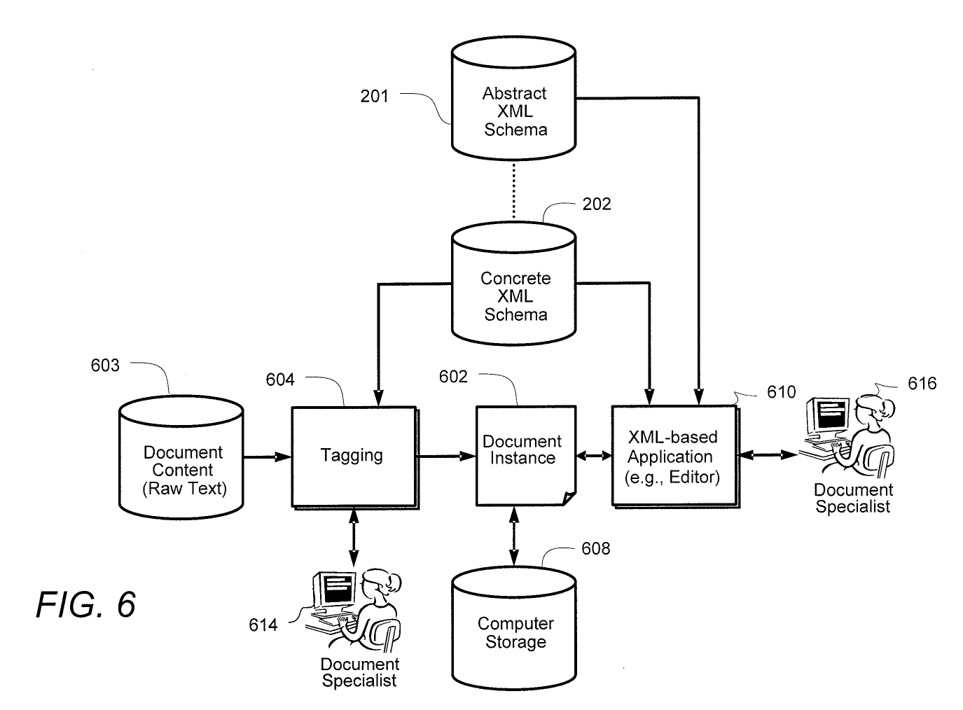

FIG. 6 in a data flow diagram illustrates one embodiment of a process of creating and editing a document instance 602. The creation of an XML document instance 602 includes applying markup to nested blocks of raw text 603 in a process termed “tagging” via a tagging module 604. The tags used to mark up the raw text are obtained from a particular Concrete XML Schema 202 which is associated with a particular Abstract XML Schema 201 and which defines the permissible tags and structure of a valid document instance 602. In the module 604, the markup may be applied manually by a document specialist 614 or through additional software. The result of the tagging process, the document instance 602, contains the document content and markup which conforms to the Concrete XML Schema 202 which, in turn, conforms to the underlying Abstract Model, which is represented by the Abstract XML Schema 201. Since the tagging module is customized to function with the Abstract XML Schema 201, the module will operate with any Concrete XML Schema that is derived from the Abstract XML Schema. Attribute information contained within the document instance and the Concrete XML Schema 202 is used to coordinate the tagging operation with the tags and structure defined by the schemas; however, the attribute information is hidden from the document specialist who sees the document instance according to the user model. Once created, an XML document instance 602 is typically stored on computer media 608, such as a disk drive, for subsequent maintenance and use.

Still referring to FIG. 6, the subsequent maintenance and use of an XML document instance 602 includes retrieving the document instance 602 and associated XML schemas from the computer storage 608. A document specialist 616 interacts with the document instance 602, based on the control of the XML schemas, for example, using XML-based application software 610, which can perform a variety of actions. These actions may include, but are not limited to, editing the document instance 602, querying information within the document instance 602, and formatting the document instance 602 for visual presentation. The system may operate in a manner similar to when the document instance 602 was originally tagged; that is, the document instance 602 contains the document content and markup which conforms to the Concrete XML Schema 202 which, in turn, conforms to the underlying Abstract Model, which is represented by the Abstract XML Schema 201. Desirably, when the application module 610 is customized to function with the Abstract XML Schema 201, it can operate with any Concrete XML Schema 202 that is derived from the Abstract XML Schema 201. Attribute information contained within the document instance, Concrete XML Schema 202, and/or Abstract XML Schema 201 is used to coordinate operation of the application module 610 with the tags and structure defined by the schemas; however, the attribute information may be hidden from the document specialist 617 who sees the document instance according to the user model.

Listing 8 in Table 18 shows a document instance 602 tagged in compliance with the Concrete XML Schema 202 for the “book” example of FIG. 4. Note the reference to the Concrete XML Schema 202 (book.xsd) with which this document instance 602 conforms. The tag names in the document instance 602 correspond to the names defined in the Concrete XML Schema 202 for “book” type documents (refer to listing 4 above).

TABLE 18
Listing 8: Document Instance Conforming to the
“Book” Concrete XML Schema Example (MobyDick.book)

| | |
|---|---|
| 1: | <?xml version=“1.0” encoding=“UTF-8” standalone=“yes”?> |
| 2: | <Book |
| 3: | xmlns=“urn:xcential:book” |
| 4: | xmlns:xsi=“http://www.w3.org/2001/XMLSchema-instance” |
| 5: | xsi:schemaLocation=“urn:xcential:book ./book.xsd”> |
| 6: | <Title>Moby Dick</Title> |
| 7: | <Author>Herman Melville</Author> |
| 8: | <Printed>1851</Printed> |
| 9: | <Chapter> |
| 10: | <Heading>Chapter 1: Loomings.</Heading> |
| 11: | <Paragraph>Call me Ishmael. Some years ago--never |
| 12: | mind how long precisely--having little or no money in my |
| 13: | purse, and nothing particular to interest me on shore, I |
| 14: | thought I would sail about a little and see the watery part |
| 15: | of the world.</Paragraph> |
| 16: | <Paragraph>It is a way I have of driving off |
| 17: | the spleen and regulating the circulation.</Paragraph> |
| 18: | </Chapter> |
| 19: | </Book> |

Listing 9 of Table 19 shows a document instance tagged in compliance with the Concrete XML Schema for the “story” example in FIG. 4. Note the reference to the Concrete XML Schema (story.xsd) with which this document instance 602 conforms. The tag names in the document instance 602 correspond to the names defined in the Concrete XML Schema 202 for “story” type documents (refer to listing 7).

TABLE 19
Listing 9: Document Instance Conforming to the
“Story” Concrete XML Schema Example (Bartleby.story)

| | |
|---|---|
| 1: | <?xml version=“1.0” encoding=“UTF-8” standalone=“yes”?> |
| 2: | <Story |
| 3: | xmlns=“urn:xcential:story” |
| 4. | xmlns:xsi=“http://www.w3.org/2001/XMLSchema-instance” |
| 5: | xsi:schemaLocation=“urn:xcential:story ./story.xsd”> |
| 6: | <Title>Bartleby the Scrivener: A Story of Wall-Street</Title> |
| 7: | <Submitter>Herman Melville</Submitter> |
| 8: | <Published>1853</Published> |
| 9: | <Body> |
| 10: | <Para>I am a rather elderly man. The nature of my |
| 11: | avocations for the last thirty years has brought me into |
| 12: | more than ordinary contact with what would seem an |
| 13: | interesting and somewhat singular set of men of whom as yet |
| 14: | nothing that I know of has ever been written:-- I mean the |
| 15: | law-copyists or scriveners.</Para> |
| 16: | <Para>I have known very many of them, |
| 17: | professionally and privately, and if I pleased, could |
| 18: | relate |
| 19: | divers histories, at which good-natured gentlemen might |
| 20: | smile, and sentimental souls might weep.</Para> |
| 21: | </Body> |
| | </Story> |

### 3.4. Converting a Document Instance from One Concrete XML Schema to Another

One embodiment includes a method of converting of a document instance from conforming to one Concrete XML Schema 202 to conforming to another Concrete XML Schema 202, provided that both Concrete XML Schemas 202 are derived from the same Abstract XML Schema 201.

The process of converting a document instance from conformance with one Concrete XML Schema 202 to another variant Concrete XML Schema 202 may be used in situations where different companies or organizations use similar or identical document content maintained using variant Concrete XML Schemas 202 derived from the same Abstract XML Schema 201. An example of this situation is the legislative bodies of the different states within the United States. Each state has their own variant of legislative document structure, and they share some amount of legislative document content.

One embodiment facilitates the conversion of a document instance from one Concrete XML Schema 202 to another Concrete XML Schema 202 because, although a Concrete XML Schema 202 contains the user model of the document structure and identifies the document components using names obtained from the user model, each Concrete XML Schema 202 also contains information that associates the names obtained from the user model with the role names of the underlying model contained within the Abstract XML Schema 201. By converting a document instance to a form in which the structure is represented in the Abstract XML Schema 201, the document instance can be easily converted, a second time, to any Concrete XML Schema 202 that was derived from the Abstract XML Schema 201.

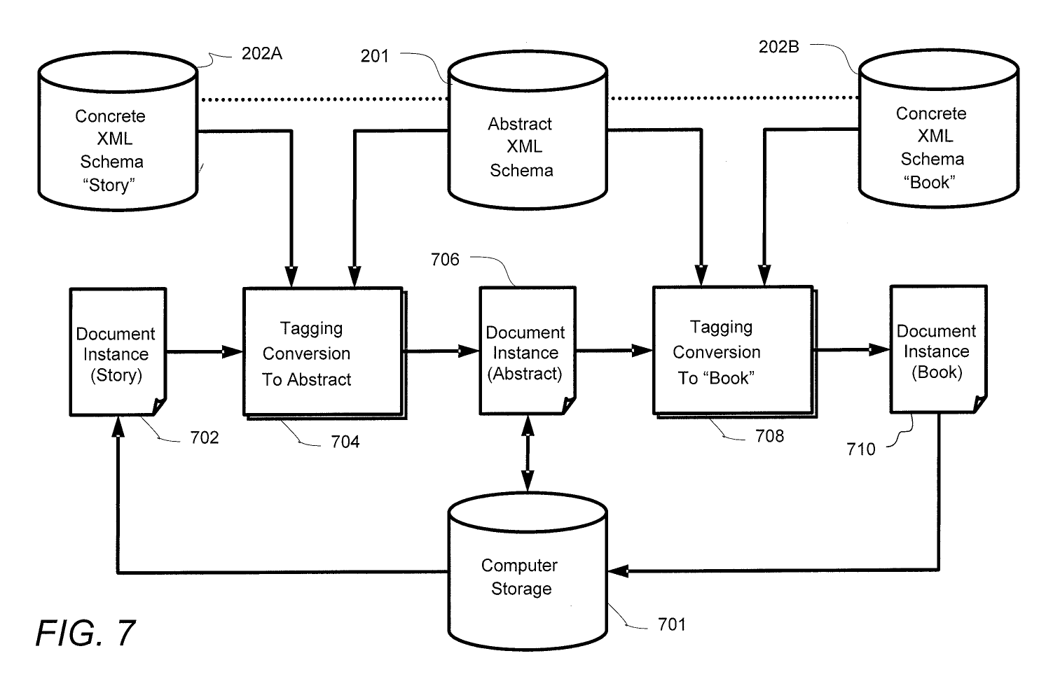

FIG. 7 is a data flow diagram that illustrates one embodiment of a process of converting of a document instance from conforming to one Concrete XML Schema 202 to conforming to another Concrete XML Schema 202. For example, the Concrete XML Schemas for “Story” 202A and “Book” 202B are both derived from the Abstract XML Schema 201, as indicated by the dotted lines in FIG. 7. Given a document instance 702, which is retrieved from a computer storage 701 and that is tagged, in conformance with the “Story” Concrete XML Schema 202A, the document instance is processed by a module 704 that converts the tags within the document instance 702 to those represented in the Abstract XML Schema 201 to create an abstract document instance 706. The abstract document instance 702 now represented in the Abstract XML Schema 201, is processed by another tag conversion module 708, which reads the “Book” Concrete XML Schema 202B and converts the tagging so the contents of the abstract document instance 706 are represented in the “Book” Concrete XML Schema 202B in a converted document instance 710. The converted document instance 710 is may be placed back into computer storage 701.

The conversion operates because the XML element attribute information contained within the document instances and schemas permits the tags to be transliterated and the document structure 702, 706, and 710 to be mapped among the various schemas.

Listing 10 of Table 20 shows a “book” document instance (402 of FIG. 4) represented in the Abstract XML Schema 201.

TABLE 20
Listing 10: “Book” Represented in Abstract XML Schema
(MobyDick.xsim)

| | |
|---|---|
| 1: | |
| 2: | <?xml version=“1.0” encoding=“UTF-8” standalone=“yes”?> |
| 3: | <xsim:Document |
| 4: | xmlns=“urn:xcential:book” |
| 5: | xmlns:xsim=“urn:xcential:xsim” |
| 6: | xmlns:dc=“http://purl.org/dc/elements/1.1/” |
| 7: | xmlns:xsi=“http://www.w3.org/2001/XMLSchema-instance” |
| 8: | xsi:schemaLocation=“urn:xcential:xsim ./xsim.xsd” |
| 9: | class=“Book”> |
| 10: | <xsim:Property class=“Title” |
| 11: | role=“dc:title”>Moby Dick</xsim:Property> |
| 12: | <xsim:Property class=“Author” |
| 13: | role=“dc:creator”>Herman Melville</xsim:Property> |
| 14: | <xsim:Property class=“Printed” |
| 15: | role=“dcterms:issued”>1851</xsim:Property> |
| 16: | <xsim:Division class=“Chapter”> |
| 17: | <xsim:Block class=“Heading”>Chapter 1: |
| | Loomings.</xsim:Block> |
| 18: | <xsim:Block class=“Paragraph”>Call me Ishmael. Some years |
| 19: | ago--never mind how long precisely--having little or no |
| 20: | money in my purse, and nothing particular to interest me |
| 21: | on shore, I thought I would sail about a little and see |
| 22: | the watery part of the World.</xsim:Block> |
| 23: | <xsim:Block class=“Paragraph”>It is a way I have of driving |
| 24: | off |
| 25: | the spleen and regulating the circulation.</xsim:Block> |
| | </xsim:Division> |
| | </xsim:Document> |

### Listing 11 of Table 21 shows a “story” document instance (404 of FIG. 4) represented in the Abstract XML Schema 201.

TABLE 21
Listing 11: “Story” Represented in Abstract XML Schema
(Bartleby.xsim)

| | |
|---|---|
| 1: | |
| 2: | <?xml version=“1.0” encoding=“UTF-8” standalone=“yes”?> |
| 3: | <xsim:Document |
| 4: | xmlns=“urn:xcential:story” |
| 5: | xmlns:xsim=“urn:xcential:xsim” |
| 6: | xmlns:dc=“http://purl.org/dc/elements/1.1/” |
| 7: | xmlns:xsi=“http://www.w3.org/2001/XMLSchema-instance” |
| 8: | xsi:schemaLocation=“urn:xcential:xsim ./xsim.xsd” |
| 9: | class=“ShortStory”> |
| 10: | <xsim:Property class=“Title” |
| 11: | role=“dc:title”>Bartleby the Scrivener: A Story |
| 12: | of Wall-Street</xsim:Property> |
| 13: | <xsim:Property class=“Submitter” |
| 14: | role=“dc:creator”>Herman Melville</xsim:Property> |
| 15: | <xsim:Property class=“Published” |
| 16: | role=“dcterms:issued”>1853</xsim:Property> |
| 17: | <xsim:Division class=“Body”> |
| 18: | <xsim:Block class=“Para”>I am a rather elderly man. The nature |
| 19: | of my avocations for the last thirty years has brought me |
| 20: | into more than ordinary contact with what would seem an |
| 21: | interesting and somewhat singular set of men of whom as yet |
| 22: | nothing that I know of has ever been written:-- I mean the |
| 23: | law-copyists or scriveners.</xsim:Block> |
| 24: | <xsim:Block class=“Para”>I have known very many of them, |
| 25: | professionally and privately, and if I pleased, could |
| 26: | relate |
| 27: | divers histories, at which good-natured gentlemen might |
| 28: | smile, and sentimental souls might weep.</xsim:Block> |
| | </xsim:Division> |
| | </xsim:Document> |

A simplified example that illustrates the results of the conversion of a portion of document instance 702 from conforming to one Concrete XML Schema 202A to another Concrete XML Schema 202B follows:
1. User model “story”; represented in “Story” Concrete Schema 202A prior to conversion to “book” user model:
   <Published>1851</Published>
2. User model “story”; represented in Abstract Schema 201 prior to conversion to “book” user model:
   <xsim:Property class=“Published”
      role=“dcterms:issued”1>1851</xsim:Property>
3. User model “book”; represented in Abstract Schema 201 after conversion:
   <xsim:Property class=“Printed”
      role=“dcterms:issued”1>1851</xsim:Property>
4. User model “book”; represented in “Book” Concrete Schema after conversion:
   <Printed>1851</Printed>

### 3.5. Querying a Collection of Document Instances

One embodiment includes a method of querying and retrieval of information from a collection of document instances which conform to Concrete XML Schemas 202 that are all derived from the same Abstract XML Schema 201. The technique allows queried elements to be specified by their underlying identity, rather than the names defined in the Concrete XML Schemas. This eliminates the need for a document specialist to be familiar with all of the user-defined element names that are defined within a collection of related documents. Instead, the document specialist can formulate the query in terms of the underlying model; the results can be presented either in terms of the underlying model or the concrete model with which each document instance conforms.

Several example queries, based upon the “book” and “story” schemas and document instances, are provided (see previous listings):
1. To retrieve all of the properties in the document instances:
   //[@base=“xsim:property”]
2. To retrieve all of the authors and submitters in the document instances:
   //[@base=“xsim:Property” and @role=“dc:creator”]
3. To retrieve all of the years published or printed in the document instances:
   //[@base=“xsim:Property” and @role=“dcterms:issued”]
4. To retrieve all of the paragraphs in the document instances:
   //[@base=“xsim:Block” and @role=“xhtml:p”]

One embodiment also include a method of referring to elements using the names defined in Concrete XML Schemas 202 (that is, in customer terms), regardless of the schema being used. Example queries, based upon the “book” and “story” schemas and document instances, are provided:
1. To refer to the author or submitter contained within a set of document instances:
   //[@base=“xsim:Property” and @role=“dc:creator”]/@class
   For a document instance written in conformance with the “book” concrete schema, the returned value will be: Author.
   For a document instance written in conformance with the “story” concrete schema, the returned value will be: Submitter.
2. To refer to the year published or printed contained within a set of document instances:
   //[@base=“xsim:Property” and @role=“dcterms:issued”]/@class

For a document instance written in conformance with the “book” concrete schema, the returned value will be: Printed.

For a document instance written in conformance with the “story” concrete schema, the returned value will be: Published.

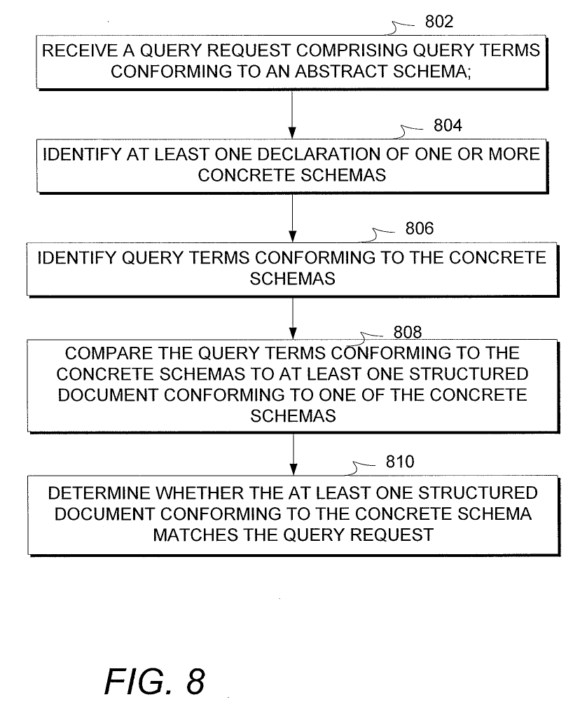

FIG. 8 is a flowchart illustrating one embodiment of a method of searching XML documents conforming to Concrete XML Schemas 202 derived from Abstract XML Schemas 201. The method begins at a block 802 in which a search engine (which may be implemented on a server in response to a client over a network, or as a standalone search engine in a computer system) receives a query request comprising query terms conforming to an Abstract XML Schema 201. In one embodiment, the query terms conforms to a first Concrete XML Schema 202. The search engine identifies a declaration in the first Concrete XML Schema 202 and a declaration in the Abstract XML Schema 202. The declaration is associated with the query terms conforming to the first Concrete XML Schema 202. The declaration of the first Concrete XML Schema 202 is derived from the declaration in the Abstract XML Schema 201. The search engine identifies the query terms conforming to the Abstract XML Schema 201 based on the declaration. Thus, the search method may be performed using query terms that are expressed in either of the Abstract XML Schema 201 or the first Concrete XML Schema 202.

Next at a block 804, the search engine identifies at least one declaration of one or more Concrete XML Schemas 202. The declaration is derived from a declaration of the Abstract XML Schema 201. Moving to a block 806, the search engine identifies query terms conforming each of the one or more Concrete XML Schemas 202. The identifying is based on the at least one declaration of the Concrete XML Schemas 202 and the received query request.

Proceeding to a block 808, the search engine compares the query terms conforming to each of the one or more Concrete XML Schemas 202 to structured documents conforming to the Concrete XML Schemas. The search engine may use different query terms for each Concrete XML Schema 202. Next a block 810, the search engine determines whether any of the structured documents matches the query request and provides search results including those matching structured documents.

### 3.6. Converting a Concrete XML Schema to a Standalone XML Schema

One embodiment includes a method that facilitates the conversion of a particular Concrete XML Schema 202 to a Standalone XML Schema for the purpose of exporting a schema and related document instances for use in a document management environment which exists outside the scope of the system described herein. In one embodiment, the method of creating a Standalone XML Schema manually using, for example, a text editor, as follows:
1. A document specialist/schema designer assembles the Concrete XML Schema 202 to be converted, the Abstract XML Schema 201 from which the Concrete XML Schema 202 is derived.
2. The initial Standalone XML Schema is created as a copy of the Concrete XML Schema 202. Further processing described below completes the transformation of the Concrete XML Schema 202 into the Standalone XML Schema.
3. Each definition in the new Standalone XML Schema is analyzed to see if it is derived from an element type definition in the Abstract XML Schema 202. For each definition that is derived from an element definition in the Abstract XML Schema, the content of the derived definition is copied into the deriving definition and the tags specifying the derivation are removed. Two types of derivation (or inheritance) may include:
   a. If the derivation is an “extension,” then the two derivations are additive, e.g., the attributes from both definitions are added together and the elements defined in the derived definition are prepended before the elements defined in the deriving definition.
   b. If the derivation is a “restriction,” the attributes are merged such that any attributes defined in the deriving definition will override or further restrict the definition found in the derived definition. The elements defined in the deriving definition, if any, will override the elements defined in the derived definition.

This process is recursive so that derivation chains—one definition deriving from another definition that itself derives from another—are handled.
1. All references to elements declared in the Abstract XML Schema 201 are modified. The declarations and definitions are repeated in the new Standalone Schema, recursively removing references to the base Abstract XML Schema 201 described above.
2. Once all derivations have been folded into the deriving schema, all references to the base schema (or schemas) are removed.

### For example, given a portion of the Concrete XML Schema 202 for the “book” example (listing 12) shown below in Table 22:

TABLE 22
Listing 12: Portion of Concrete XML Schema for “Book” Document

| 1: | <xsd:complexType name=“BookType”> | |
|---|---|---|
| 2: | <xsd:complexContent> | |
| 3: | <xsd:restriction base=“xsim:DocumentType”> | |
| 4: | <xsd:sequence> | |
| 5: | <xsd:element ref=“xsim:Property” minOccurs=“0” | |
| 6: | maxOccurs=“unbounded”/> | |
| 7: | <xsd:element ref=“Chapter” minOccurs=“0” | |
| 8: | maxOccurs=“unbounded”/> | |
| 9: | </xsd:sequence> | |
| 10: | <xsd:attribute name=“class” | type=“xsd:string” |
| 11: | | fixed=“Book”/> |
| 12: | <xsd:attribute name=“base” | type=“xsd:string” |
| 13: | | fixed=“xsim:Document”/> |
| 14: | </xsd:restriction> | |
| 15: | </xsd:complexContent> | |
| 16: | </xsd:complexType> | |

and further given a portion of the Abstract XML Schema from which the Concrete XML Schema in listing 12 is derived (listing 13) shown below in Table 23:

TABLE 23
Listing 13: Portion of Abstract XML Schema for “Book” Document

| 1: | <xsd:complexType name=“DocumentType”> | |
|---|---|---|
| 2: | <xsd:sequence> | |
| 3: | <xsd:element ref=“Property” | minOccurs=“0” |
| 4: | | maxOccurs=“unbounded”/> |
| 5: | <xsd:element ref=“Division” | minOccurs=“0” |
| 6: | | maxOccurs=“unbounded”/> |

| | |
|---|---|
| 7: | </xsd:sequence> |
| 8: | <xsd:attributeGroup ref=“derivationGroup”/> |
| 9: | </xsd:complexType> |

the following Standalone XML Schema (listing 14) is generated by applying the processing steps to the Concrete XML Schema 202 (listing 12) and the Abstract XML Schema 201 from which it is derived (listing 13) in Table 24:

TABLE 24
Listing 14: Portion of Standalone XML Schema for “Book” Document

| 1: | <xsd:complexType name=“BookType”> | |
|---|---|---|
| 2: | <xsd:sequence> | |
| 3: | <xsd:element ref=“Property” | minOccurs=“0” |
| 4: | | maxOccurs=“unbounded”/> |
| 5: | <xsd:element ref=“Chapter” | minOccurs=“0” |
| 6: | | maxOccurs=“unbounded”/> |
| 7: | </xsd:sequence> | |

| | | |
|---|---|---|
| 8: | <xsd:attribute name=“class” | type=“xsd:string” fixed=“Book”/> |
| 9: | <xsd:attribute name=“base” | type=“xsd:string” |
| 10: | | fixed=“xsim:Document”/> |

| | |
|---|---|
| 11: | <xsd:attribute name=“type” type=“xsd:string” |
| 12: | use=“optional”/> |
| 13: | <xsd:attribute name=“role” type=“xsd:string” |
| | use=“optional”/> |
| | </xsd:complexType> |

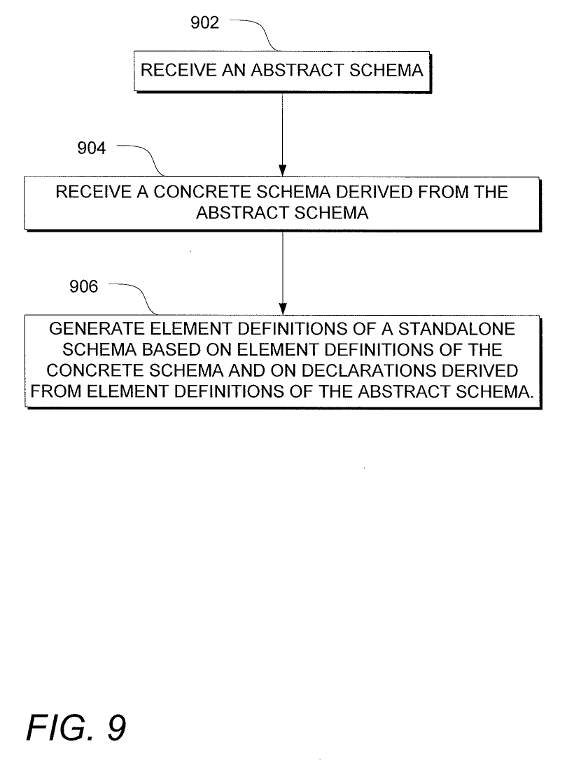

FIG. 9 is a flowchart illustrating one embodiment of a method of generating a Standalone XML Schema. The method begins at a block 902 in which a processor receives an Abstract XML Schema, e.g., from a data storage system. Next at a block 904, the processor receives a Concrete XML Schema derived from an Abstract Schema. The Concrete XML Schema may comprise a plurality of element definitions.

Proceeding to a block 906, the processor generates element definitions of the Standalone XML Schema based on the plurality of element definitions of the Concrete XML Schema and on declarations derived from the element definitions of the Abstract XML Schema. In one embodiment, this generating includes generating elements and attributes of the ones of the element definitions based on the respective element definitions of the Abstract XML Schema.

It is to be recognized that depending on the embodiment, certain acts or events of any of the methods described herein can be performed in a different sequence, may be added, merged, or left out all together (e.g., not all described acts or events are necessary for the practice of the method). Moreover, in certain embodiments, acts or events may be performed concurrently, e.g., through multi-threaded processing, interrupt processing, or multiple processors, rather than sequentially.

Those of skill will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A method of converting a structured document from a first schema to a second schema, the method comprising:
receiving a first structured document comprising at least one element conforming to a first schema;
identifying a declaration in the first schema and a declaration in the abstract schema that is associated with the element, wherein the declaration of the first schema is derived from the declaration in the abstract schema;
identifying a declaration in a second schema that is derived from the declaration in the abstract schema; and
generating an element of a second structured document based at least partly on the declaration in the second schema, wherein the element of the second document conforms to the second schema.

2. The method of claim 1, further comprising generating an element of an intermediate document based on the declaration of the abstract schema and the declaration of the first schema.

3. The method of claim 1, further comprising outputting the element of the second document.

4. The method of claim 1, further comprising storing the second document.

5. The method of claim 1, wherein at least one of the first and second structured documents comprise XML documents.

6. The method of claim 1, wherein the first schema comprises a concrete schema.

7. The method of claim 1, wherein the second schema comprises a concrete schema.

8. The method of claim 1, wherein the declaration of the first schema comprises at least one attribute relating at least one element of the first schema with at least one element of the abstract schema.

9. The method of claim 8, wherein the at least one attribute comprises at least one of a base attribute, a type attribute, a class attribute, or a role attribute

10. A method of generating a structured document, the method comprising:
receiving at least one element conforming to a first schema;
identifying a declaration in the first schema that is associated with the received element and which is derived from a declaration in an abstract schema;
generating an element of a structured document based at least partly on the declaration in the abstract schema, wherein the element of the structured document conforms to the first schema.

11. The method of claim 10, further comprising outputting the element of the document.

12. An XML document stored on a computer readable medium, the document comprising:
at least one element conforming to a concrete schema derived from an abstract schema,
wherein the concrete schema comprises a plurality of declarations derived from respective declarations of the abstract schema.

13. A method of searching structured documents, the method comprising:
receiving a query request comprising query terms conforming to an abstract schema;
identifying at least one declaration of at least one concrete schema, the declaration being derived from a declaration of the abstract schema;
identifying query terms conforming to the concrete schema, wherein the identifying is based on the at least one declaration of the concrete schema and the received query request;
comparing the query terms conforming to the concrete schema to at least one structured document conforming to the concrete schema; and
determining whether the at least one structured document conforming to the concrete schema matches the query request.

14. The method of claim 13, wherein receiving the query request comprises:
receiving query terms conforming to a first concrete schema;
identifying a declaration in the first concrete schema and a declaration in the abstract schema that is associated with the query terms conforming to the first concrete schema, wherein the declaration of the first concrete schema is derived from the declaration in the abstract schema; and
identifying the query terms conforming to the abstract schema based on the declaration.

15. The method of claim 13, wherein identifying the at least one declaration of the at least one concrete schema comprises identifying at least one declaration of each of a plurality of concrete schemas, the respective declaration of each of the plurality of schemas being derived from a declaration of the abstract schema; and
wherein comparing the query terms conforming to the concrete schema to at least one structured document conforming to the concrete schema comprises comparing the query terms conforming to the concrete schema to at least one structured document conforming to one of the plurality of concrete schemas.

16. The method of claim 13, wherein comparing the query terms conforming to the concrete schema to at least one document comprises accessing a database of documents conforming to the at least one concrete schema.

17. The method of claim 16, further comprising:
receiving, over a network, a document conforming to the concrete schema; and
storing the document in the database.

18. The method of claim 13, wherein the at least one declaration comprises at least one attribute associating at least one element of the first schema with at least one element of the second schema.

19. The method of claim 18, wherein the at least one attribute comprises at least one of a base attribute, a type attribute, a class attribute, or a role attribute

20. A method of generating a standalone schema for defining structured documents, the method comprising:
receiving an abstract schema;
receiving a concrete schema derived from the abstract schema, the concrete schema comprising a plurality of element definitions; and
generating element definitions of a standalone schema based on the plurality of element definitions of the concrete schema and on declarations derived from the element definitions of the abstract schema.

21. The method of claim 20, wherein generating said element definitions of the standalone schema comprises generating elements and attributes of the ones of the element definitions based on the respective element definitions of the abstract schema.
